(19) United States
(12) Patent Application Publication
(10) Pub. No.: US 2025/0313662 A1
(43) Pub. Date: Oct. 9, 2025

(54) IRON-CATALYZED METATHESIS POLYMERIZATION OF OLEFINS

(71) Applicant: YEDA RESEARCH AND DEVELOPMENT CO. LTD., Rehovot (IL)

(72) Inventors: David MILSTEIN, Rehovot (IL); Satoshi TAKEBAYASHI, Rehovot (IL)

(73) Assignee: YEDA RESEARCH AND DEVELOPMENT CO. LTD., Rehovot (IL)

(21) Appl. No.: 18/292,946

(22) PCT Filed: Aug. 1, 2022
(86) PCT No.: PCT/IL2022/050830

§ 371 Date: Jan. 29, 2024

Related U.S. Application Data
(60) Provisional application No. 63/228,105, filed on Aug. 1, 2021.

(51) Int. Cl. C08G 61/08; C07F 9/58; C07F 15/02

(52) U.S. Cl. CPC C08G 61/08; C07F 9/58; C07F 15/02; C07B 2200/05; C08G 2261/11; C08G 2261/228; C08G 2261/3324; C08G 2261/418

(57) ABSTRACT

This invention is directed to iron-based complexes, and uses thereof for catalytic olefin metathesis reaction, including ring opening metathesis polymerization of olefins.

### FIELD OF THE INVENTION

This invention is directed to iron-based complexes, and uses thereof for catalytic olefin metathesis reaction, including ring opening metathesis polymerization of olefins.

### BACKGROUND OF THE INVENTION

The olefin metathesis reaction is among the most important catalytic carbon-carbon double bond formation reactions. The utility of olefin metathesis reaction has been demonstrated in a range of industrial processes for the synthesis of polymers, and bulk and fine chemicals. Currently, Mo and Ru carbene complexes are state-of-the-art, commercially available, and the most widely used catalysts for this reaction, however Ru catalysts have economical and toxicological drawbacks [J. Suriboot, H. S. Bazzi, D. E. Bergbreiter, Polymers. 8, 140 (2016)].

A few 3d early-transition metal catalysts [L. R. Gilliom, R. H. Grubbs, J. Am. Chem. Soc. 108, 733 (1986); X. How, K. Nomura, J. Am. Chem. Soc. 137, 4662 (2015)] and an organo-redox mediated system [K. A. Ogawa, A. E. Goetz, A. J. Boydston, J. Am. Chem. Soc. 137, 1400 (2015)] were reported for ring-opening metathesis polymerization (ROMP) of cyclic olefins, however, there is no report of an iron-based olefin metathesis catalyst.

Being the most abundant and biocompatible transition metal, a catalyst based on iron is challenging, due to the tendency of iron alkylidene complexes, which are envisioned as intermediates in this reaction, to catalyze alkene cyclopropanation.

There are several reports aimed at the development of iron catalyzed metathesis reactions. Grubbs showed that an iron-carbene complex could not be prepared using a common strategy used to prepare Ru-carbene complexes [J. Louie, R. H. Grubbs, Organometallics 20, 481 (2001)]. Chirik [S. K. Russell, J. M. Hoyt, S. C. Bar, C. Milsmann, S. C. E. Stieber, S. P. Semproni, S. DeBeerbc, P. J. Chirik, Chem. Sci. 5, 1168 (2014)] and Wolczanski [B. M. Lindley, B. P. Jacobs, S. N. MacMillan, P. T. Wolczanski, Chem. Commun. 52, 3891 (2016)] discovered stable iron-carbene complexes using pincer-type ligands, however these complexes did not react with olefins despite the existence of possible coordination sites.

It is, therefore, an important challenge to discover catalysts based on earth-abundant and non-toxic metals.

### SUMMARY OF THE INVENTION

In one embodiment, this invention is directed to an iron complex represented by the structures of formula A1, its dimer A2 or isomers thereof:

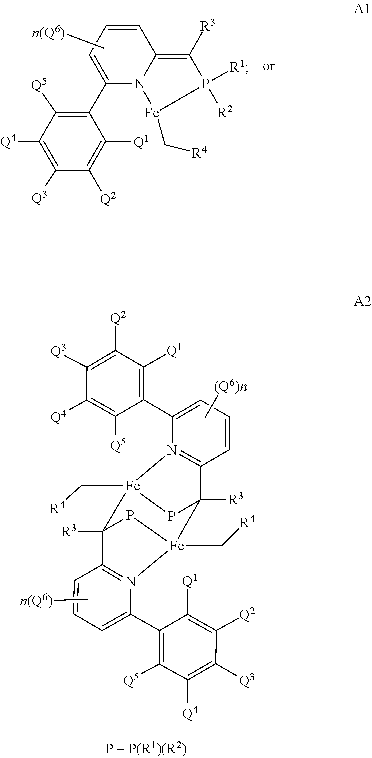

wherein
R¹ and R² are each independently linear or branched alkyl, cycloalkyl, aryl, heterocyclyl, alkylcycloalkyl, alkylaryl, or alkylheterocyclyl;
R³ is H, D, linear or branched alkyl;
R⁴ is SiHₓ(alkyl)_{y}(aryl)_{z} or CHₓ(alkyl)_{y}(aryl)_{z}; wherein x is an integer between 0-3; y is an integer between 0-3; z is an integer between 0-3; wherein x+y+z is 3.
Q¹, Q², Q³, Q⁴ Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino; and
n is an integer between 1 and 3.

In another embodiment the iron complex of formula A1 and A2 of this invention is a catalyst.

In one embodiment, this invention is directed to an iron complex represented by the structures of formula A3:

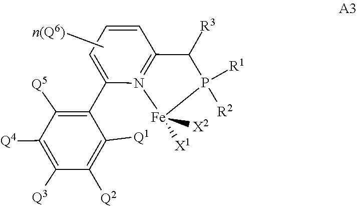

wherein:
R¹ and R² are each independently linear or branched alkyl, cycloalkyl, aryl, heterocyclyl, alkylcycloalkyl, alkylaryl, or alkylheterocyclyl;
R³ is H, D, linear or branched alkyl;
X¹ and X² are each independently Cl, Br, I or F;
Q¹, Q², Q³, Q⁴, Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino; and
n is an integer between 1 and 3.

In another embodiment, the iron complex of formula A3 is a precursor for the preparation of the iron complexes of formula A1 and A2.

In some embodiment, this invention is directed to a method for metathesis polymerization of cyclic olefins comprising reacting a substituted or unsubstituted cyclic olefin with the iron complex of formula A1 or A2, thereby obtaining a polymer (by ring opening metathesis polymerization).

In some embodiment, the cyclic olefin has a strain in the ring. In one embodiment, the cyclic olefin is a 3, 4 or 5 membered ring. In one embodiment, the cyclic olefin is bicyclic. In one embodiment, the cyclic olefin is norbornene. In one embodiment, the cyclic olefin is carbocyclic or heterocyclic. In one embodiment, the cyclic olefin is a diene.

In one embodiment, the cyclic olefin is norbornene (substituted or unsubstituted) obtaining a polynorbornene (substituted or unsubstituted) of formula I:

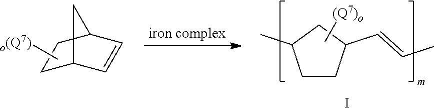

wherein Q⁷ is independently H, linear or branched alkyl, aryl, heterocyclyl, alkylcycloalkyl, alkylaryl, alkylheterocyclyl, Si(alkyl)₃, halide, nitro, amide, ester, cyano, alkoxy, NH₂, aminoalkyl or arylamino;
is an integer between 1-3; and
m is an integer larger than 2.

In some embodiments, this invention is directed to a compound represented by the structure of formula B1 or its isomers:

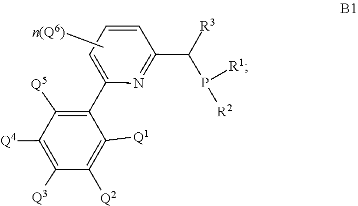

R¹ and R² are each independently linear or branched alkyl, cycloalkyl, heterocyclyl, alkylcycloalkyl, alkylaryl, or alkylheterocyclyl;
R³ is H, D, linear or branched alkyl;
Q¹, Q², Q³, Q⁴ Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino; and
n is an integer between 1 and 3.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A-1B present synthetic schemes for the preparation of iron complexes of this invention. FIG. 1A presents preparation of complex A1 from complex A3. Specifically, preparation of complexes 9, 10, 11 and 12 from complexes 1, 2, 3 and 8 respectively. FIG. 1B presents a reaction between A1 and 4-dimethylaminopyridine where 4 coordinated iron complex is obtained following a reaction with BPh₃ to obtain again complex A1. Specifically, preparation of complex 14 from complex 9. Complex 9 can be further obtained by addition of BPh₃.

FIG. 2A-2C present X-ray structures of complexes of this invention with 50% probability ellipsoids. H atoms, except H(1), and solvent molecules are omitted for clarity FIG. 2A: X-ray structure of 11: selected bond lengths (Å): Fe(1)-C(27) 2.0176(18); selected bond angles (0): Fe(1)-C(27)-Si(1) 122.10(10). FIG. 2B: X-ray structure of 13 (dimer of 12): selected bond lengths (Å): Fe(1)-C(28) 2.0683(15); selected bond angles (°): Fe(1)-C(28)-Si(1) 124.56(8). FIG. 2C: X-ray structure of 14. H atoms, except CHPiPr₂, and solvent molecules are omitted for clarity. Selected bond lengths (Å): Fe(1)-C(25) 2.045(4), Fe(1)-N(2) 2.106(3), Fe(1)-P(1) 2.4448(11), Fe(1)-N(1) 2.057(3), C(1)-C(2) 1.371(5). Selected bond angles: N(1)-Fe(1)-P(1) 84.02(9), N(2)-Fe(1)-C(25) 106.73(14), P(1)-C(1)-C(2) 121.9(3), Fe(1)-C(25)-Si(1) 119.0(2).

FIG. 3A-3C present iron catalyzed ROMP (ring-opening metathesis polymerization) of norbornene and characterization of the product. FIG. 3A presents a synthetic scheme of ROMP of norbornene catalyzed by 9. FIG. 3B presents TEM image of air dried 0.058 mg/mL solution of I (polynorbornene); FIG. 3C presents partial epoxidation of I (polynorbornene) by meta-chloroperbenzoic acid (m-CPBA), and ¹H-¹H gCOSY NMR spectra of partially epoxidized I showing correlation between Hₐ and H_{b}.

FIG. 4 presents X-ray structure of 1 with 50% probability ellipsoids. H atoms and solvent molecules are omitted for clarity. Selected bond lengths (Å): Fe—Cl(1) 2.2247(6), Fe(1)-Cl(2) 2.2570(6), Fe(1)-P(1) 2.4357(6), Fe(1)-N(1) 2.1692(14), C(1)-C(2) 1.505(3). Selected bond angles (°): N(1)-Fe(1)-P(1) 79.45(4), Cl(1)-Fe(1)-Cl(2) 119.87(2), P(1)-C(1)-C(2) 109.05(13).

FIG. 5 presents X-ray structure of 2 with 50% probability ellipsoids. H atoms and solvent molecules are omitted for clarity. Selected bond lengths (Å): Fe—Br(1) 2.4036(6), Fe(1)-Br(2) 2.3687(5), Fe(1)-P(1) 2.4225(9), F(1)-N(1) 2.157(2), C(1)-C(2) 1.505(4). Selected bond angles: N(1)-Fe(1)-P(1) 80.00(7), Br(1)-Fe(1)-Br(2) 116.61(2), P(1)-C(1)-C(2) 108.9(2).

FIG. 6 presents X-ray structure of 3 with 50% probability ellipsoids. H atoms and solvent molecules are omitted for clarity. Selected bond lengths (Å): Fe(1)-Cl(1) 2.2392(13), Fe(1)-Cl(2) 2.2452(14), Fe(1)-P(1) 2.4397(14), Fe(1)-N(1) 2.157(4), C(1)-C(2) 1.500(6). Selected bond angles: N(1)-Fe(1)-P(1) 81.42(10), Cl(1)-Fe(1)-Cl(2) 120.15(5), P(1)-C(1)-C(2) 112.8(3).

FIG. 7 presents X-ray structure of 4 with 50% probability ellipsoids. H atoms and solvent molecules are omitted for clarity. Selected bond lengths (Å): Fe(1)-Cl(1) 2.2484(6), Fe(1)-Cl(2) 2.2313(6), Fe(1)-P(1) 2.4058(6), Fe(1)-N(1) 2.1638(19), C(1)-C(2) 1.532(3). Selected bond angles: N(1)-Fe(1)-P(1) 80.77(5), Cl(1)-Fe(1)-Cl(2) 116.98(3), P(1)-C(1)-C(2) 107.74(15).

FIG. 8 presents X-ray structure of 9 with 50% probability ellipsoids. H atoms and solvent molecules are omitted for clarity. Only the major conformation is presented. Selected bond lengths (Å): Fe(1)-C(25) 2.043(4), Fe(1)-N(1) 2.182(3), Fe(1)-P(1) 2.4413(15), Fe(1)-Cl(1) 2.3110(10), C(1)-C(2) 1.513(5). Selected bond angles: N(1)-Fe(1)-P(1) 80.71(9), Cl(1)-Fe(1)-C(25) 126.05(13), P(1)-C(1)-C(2) 114.2(3), Fe(1)-C(25)-Si(1) 117.3(2).

FIGS. 9A-9E present the spectra of compounds I, Va-Vd. FIG. 9A: ¹H NMR spectra of I, Va-Vd prepared in the presence of styrene (inset: expansion of 6.5 to 4.8 ppm region showing signals from end groups); FIG. 9B: ¹H-¹H-gCOSY NMR; FIG. 9C: ¹³C{¹H}NMR spectra of I, Va-Vd prepared in the presence of styrene (inset: expansion of 134 to 135 ppm region); FIG. 9D: ¹H-¹H-gCOSY NMR spectrum of partially epoxidized I, Va-Vd; and FIG. 9E: IR spectra of I, Va-Vd prepared in the presence of styrene.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

This invention is directed to iron-catalyzed metathesis polymerization of cyclic olefins. In some embodiments, this invention is directed to iron-catalyzed ring opening metathesis polymerization of olefins. This reaction enables the formation of polynorbornene with unprecedented stereoregularity and high molecular weight (>10⁷ g/mol). The iron-based catalyst of this invention involves a metal-ligand cooperation, involving dearomatization-aromatization of pyridine-based pincer ligands, which has led to the design of several new catalytic reactions.

A unique feature of these iron catalysts is that an open coordination site is formed upon dearomatization of the pyridine-based ligand, making possible the activation of incoming substrates such as H₂, CO₂, amines, and alcohols via metal-ligand cooperation.

### Iron Complexes

In some embodiments, this invention is directed to an iron complex and to methods of use thereof represented by the structure of formula A1, its dimer A2 or its isomers:

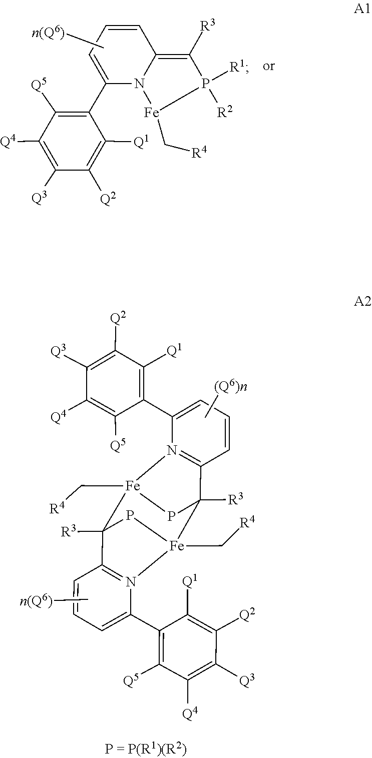

wherein
R¹ and R² are each independently linear or branched alkyl, cycloalkyl, aryl, heterocyclyl, alkylcycloalkyl, alkylaryl, or alkylheterocyclyl;
R³ is H, D, linear or branched alkyl;
R⁴ is SiHₓ(alkyl)_{y}(aryl)_{z} or CHₓ(alkyl)_{y}(aryl)_{z}; wherein x is an integer between 0-3; y is an integer between 0-3; z is an integer between 0-3; wherein x+y+z is 3.
Q¹, Q², Q³, Q⁴ Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino; and
n is an integer between 1 and 3.

In some embodiments, this invention is directed to an iron complex and methods of use thereof represented by the structure of formula A3 or its isomers:

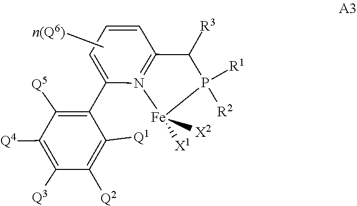

wherein:
R¹ and R² are each independently linear or branched alkyl, cycloalkyl, aryl, heterocyclyl, alkylcycloalkyl, alkylaryl or alkylheterocyclyl;
R³ is H, D, linear or branched alkyl;
X¹ and X² are each independently Cl, Br, I or F;
Q¹, Q², Q³, Q⁴, Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino; and
n is an integer between 1 and 3.

In various embodiments, the iron complexes of structures A1 and A2 are presented below:

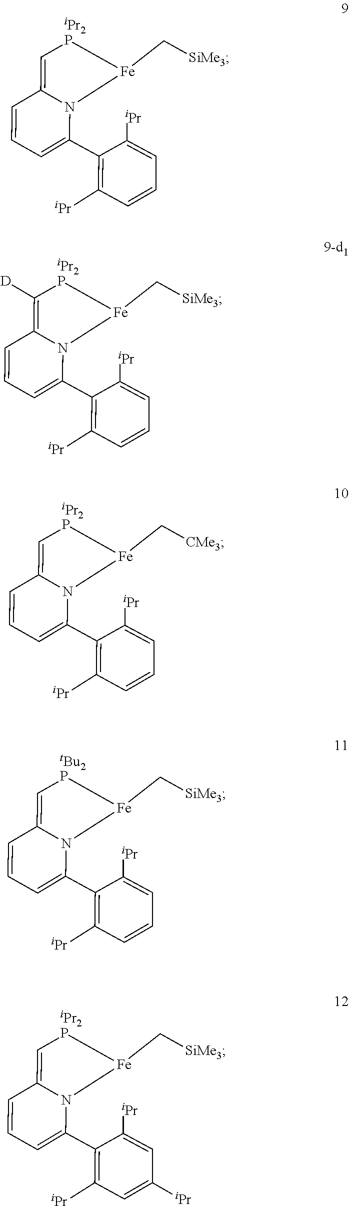

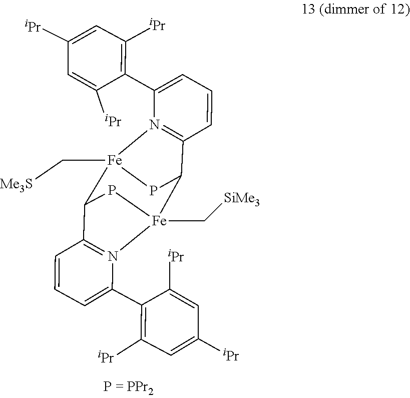

In various embodiments, the iron complexes of structures A3 are presented below:

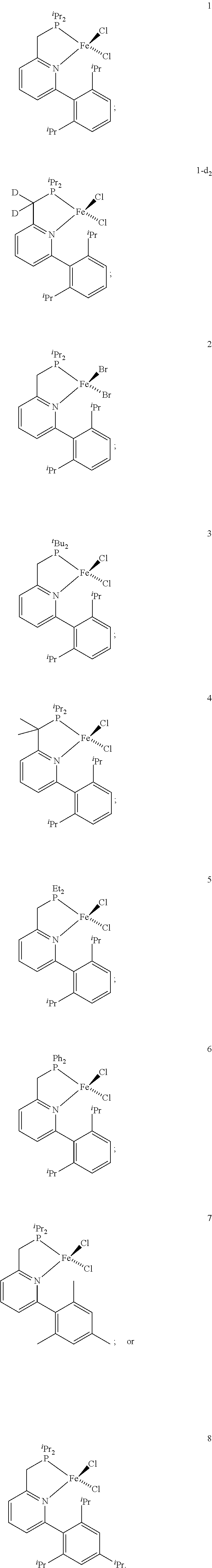

### Ligands

In some embodiments, this invention is directed to a compound by the structure of formula B1 or its isomers:

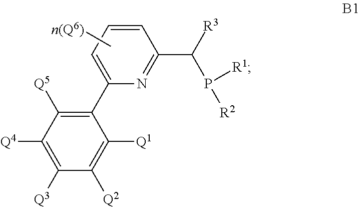

R¹ and R² are each independently linear or branched alkyl, cycloalkyl, heterocyclyl, alkylcycloalkyl, alkylaryl, or alkylheterocyclyl;
R³ is H, D, linear or branched alkyl;
Q¹, Q², Q³, Q⁴ Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino; and
n is an integer between 1 and 3.

In various embodiments, the compounds of B1 are presented below:

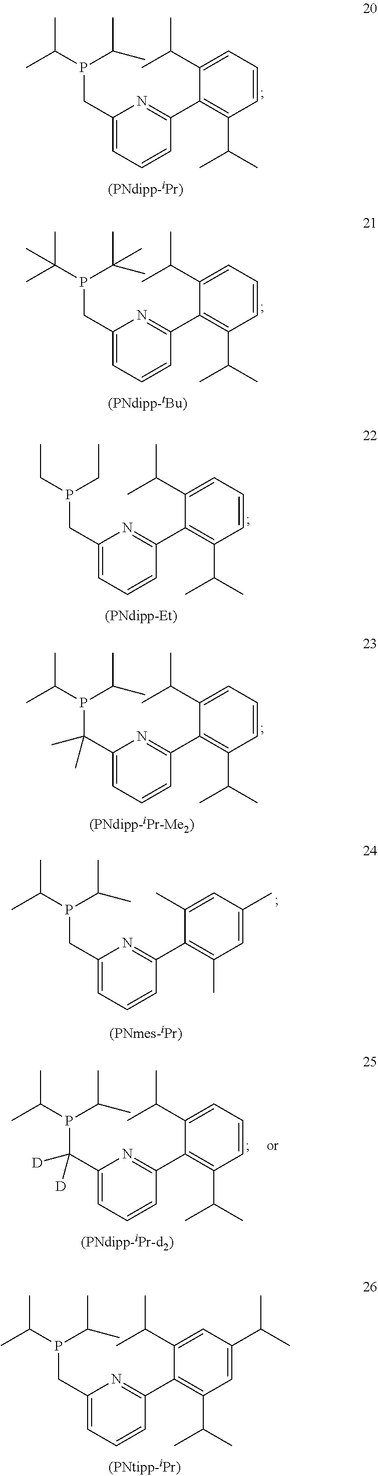

In some embodiments, the compound of formula B1 is used as a ligand for the preparation of an iron complex of this invention.

In some embodiments R¹ of the structures of formula A1, A2 A3 or B1 is a linear alkyl. In other embodiments, R¹ of the structures of formula A1, A2 A3 or B1 is a branched alkyl. In other embodiments, R¹ of the structures of formula A1, A2 A3 or B1 is cycloalkyl. In other embodiments, R¹ of the structures of formula A1, A2 A3 or B1 is aryl. In other embodiments, R¹ of the structures of formula A1, A2 A3 or B1 is heterocyclyl. In other embodiments, R¹ of the structures of formula A1, A2 A3 or B1 is alkylcycloalkyl. In other embodiments, R¹ of the structures of formula A1, A2 A3 or B1 is alkylaryl. In other embodiments, R¹ of the structures of formula A1, A2 A3 or B1 is alkylheterocyclyl.

In some embodiment R² of the structures of formula A1, A2 A3 or B1 is a linear alkyl. In other embodiments, R² of the structures of formula A1, A2 A3 or B1 is a branched alkyl. In other embodiments, R² of the structures of formula A1, A2 A3 or B1 is cycloalkyl. In other embodiments, R² of the structures of formula A1, A2 A3 or B1 is aryl. In other embodiments, R² of the structures of formula A1, A2 A3 or B1 is heterocyclyl. In other embodiments, R² of the structures of formula A1, A2 A3 or B1 is alkylcycloalkyl. In other embodiments, R² of the structures of formula A1, A2 A3 or B1 is alkylaryl. In other embodiments, R² of the structures of formula A1, A2 A3 or B1 is alkylheterocyclyl.

In some embodiments R³ of the structures of formula A1, A2 A3 or B1 is H. In other embodiments, R³ of the structures of formula A1, A2 A3 or B1. In other embodiments, R³ of the structures of formula A1, A2 A3 or B1 a linear alkyl. In other embodiments, R³ of the structures of formula A1, A2 A3 or B1 is a or branched alkyl.

In some embodiments R⁴ of the structures of formula A1, A2 or A3 is Si(alkyl)₃. In other embodiments, R⁴ of the structures of formula A1, A2 or A3 C(alkyl)₃. In other embodiment, R⁴ of the structures of formula A1, A2 or A3 is SiHₓ(alkyl)_{y}(aryl)_{z}. In other embodiment, R⁴ of the structures of formula A1, A2 or A3 is CHₓ(alkyl)_{y}(aryl)_{z}; wherein x is an integer between 0-3; y is an integer between 0-3; z is an integer between 0-3; wherein x+y+z is 3.

In some embodiments Q¹, of the structures of formula A1, A2 A3 or B1 is H. In other embodiments, Q¹ of the structures of formula A1, A2 A3 or B1 is linear or branched alkyl. In other embodiments, Q¹ of the structures of formula A1, A2 A3 or B1 is aryl. In other embodiments, Q¹ of the structures of formula A1, A2 A3 or B1 is heterocyclyl. In other embodiments, Q¹ of the structures of formula A1, A2 A3 or B1 is alkylcycloalkyl. In other embodiments, Q¹ of the structures of formula A1, A2 A3 or B1 is alkylaryl. In other embodiments, Q¹ of the structures of formula A1, A2 A3 or B1 is alkylheterocyclyl. In other embodiments, Q¹ of the structures of formula A1, A2 A3 or B1 is halide. In other embodiments, Q¹ of the structures of formula A1, A2 A3 or B1 is nitro. In other embodiments, Q¹ of the structures of formula A1, A2 A3 or B1 is amide. In other embodiments, Q¹ of the structures of formula A1, A2 A3 or B1 is ester. In other embodiments, Q¹ of the structures of formula A1, A2 A3 or B1 is cyano. In other embodiments, Q¹ of the structures of formula A1, A2 A3 or B1 is alkoxy. In other embodiments, Q¹ of the structures of formula A1, A2 A3 or B1 is NH₂. In other embodiments, Q¹ of the structures of formula A1, A2 or A3 is aminoalkyl. In other embodiments, Q¹ of the structures of formula A1, A2 A3 or B1 is arylamino.

In some embodiments Q² and Q⁴ of the structures of formula A1, A2 A3 or B1 are each independently H. In other embodiments, Q² and Q⁴ of the structures of formula A1, A2 or A3 are each independently a linear or branched alkyl. In other embodiments, Q² and Q⁴ of the structures of formula A1, A2 A3 or B1 are each independently an aryl. In other embodiments, Q² and Q⁴ of the structures of formula A1, A2 or A3 are each independently a heterocyclyl. In other embodiments, Q² and Q⁴ of the structures of formula A1, A2 A3 or B1 are each independently an alkylcycloalkyl. In other embodiments, Q² and Q⁴ of the structures of formula A1, A2 A3 or B1 are each independently an alkylaryl. In other embodiments, Q² and Q⁴ of the structures of formula A1, A2 A3 or B1 are each independently an alkylheterocyclyl. In other embodiments, Q² and Q⁴ of the structures of formula A1, A2 A3 or B1 are each independently a halide. In other embodiments, Q² and Q⁴ of the structures of formula A1, A2 A3 or B1 are each independently a nitro. In other embodiments, Q² and Q⁴ of the structures of formula A1, A2 A3 or B1 are each independently an amide. In other embodiments, Q² and Q⁴ of the structures of formula A1, A2 A3 or B1 are each independently an ester. In other embodiments, Q² and Q⁴ of the structures of formula A1, A2 A3 or B1 are each independently a cyano. In other embodiments, Q² and Q⁴ of the structures of formula A1, A2 A3 or B1 are each independently an alkoxy. In other embodiments, Q² and Q⁴ of the structures of formula A1, A2 A3 or B1 are each independently a NH₂. In other embodiments, Q² and Q⁴ of the structures of formula A1, A2 A3 or B1 are each independently an aminoalkyl. In other embodiments, Q² and Q⁴ of the structures of formula A1, A2 A3 or B1 are each independently an arylamino.

In some embodiments Q³, of the structures of formula A1, A2 A3 or B1 is H. In other embodiments, Q³ of the structures of formula A1, A2 A3 or B1 is linear or branched alkyl. In other embodiments, Q³ of the structures of formula A1, A2 A3 or B1 is aryl. In other embodiments, Q³ of the structures of formula A1, A2 A3 or B1 is heterocyclyl. In other embodiments, Q³ of the structures of formula A1, A2 A3 or B1 is alkylcycloalkyl. In other embodiments, Q³ of the structures of formula A1, A2 A3 or B1 is alkylaryl. In other embodiments, Q³ of the structures of formula A1, A2 A3 or B1 is alkylheterocyclyl. In other embodiments, Q³ of the structures of formula A1, A2 A3 or B1 is halide. In other embodiments, Q³ of the structures of formula A1, A2 A3 or B1 is nitro. In other embodiments, Q³ of the structures of formula A1, A2 A3 or B1 is amide. In other embodiments, Q³ of the structures of formula A1, A2 A3 or B1 is ester. In other embodiments, Q³ of the structures of formula A1, A2 A3 or B1 is cyano. In other embodiments, Q³ of the structures of formula A1, A2 A3 or B1 is alkoxy. In other embodiments, Q³ of the structures of formula A1, A2 A3 or B1 is NH₂. In other embodiments, Q³ of the structures of formula A1, A2 A3 or B1 is aminoalkyl. In other embodiments, Q³ of the structures of formula A1, A2 A3 or B1 is arylamino.

In some embodiments Q⁵, of the structures of formula A1, A2 A3 or B1 is H. In other embodiments, Q⁵ of the structures of formula A1, A2 A3 or B1 is linear or branched alkyl. In other embodiments, Q⁵ of the structures of formula A1, A2 A3 or B1 is aryl. In other embodiments, Q⁵ of the structures of formula A1, A2 A3 or B1 is heterocyclyl. In other embodiments, Q⁵ of the structures of formula A1, A2 A3 or B1 is alkylcycloalkyl. In other embodiments, Q⁵ of the structures of formula A1, A2 A3 or B1 is alkylaryl. In other embodiments, Q⁵ of the structures of formula A1, A2 A3 or B1 is alkylheterocyclyl. In other embodiments, Q⁵ of the structures of formula A1, A2 A3 or B1 is halide. In other embodiments, Q⁵ of the structures of formula A1, A2 A3 or B1 is nitro. In other embodiments, Q⁵ of the structures of formula A1, A2 A3 or B1 is amide. In other embodiments, Q⁵ of the structures of formula A1, A2 A3 or B1 is ester. In other embodiments, Q⁵ of the structures of formula A1, A2 A3 or B1 is cyano. In other embodiments, Q⁵ of the structures of formula A1, A2 A3 or B1 is alkoxy. In other embodiments, Q⁵ of the structures of formula A1, A2 A3 or B1 is NH₂. In other embodiments, Q⁵ of the structures of formula A1, A2 A3 or B1 is aminoalkyl. In other embodiments, Q⁵ of the structures of formula A1, A2 A3 or B1 is arylamino.

In some embodiments Q⁶, of the structures of formula A1, A2 A3 or B1 is H. In other embodiments, Q⁶ of the structures of formula A1, A2 A3 or B1 is linear or branched alkyl. In other embodiments, Q⁶ of the structures of formula A1, A2 A3 or B1 is aryl. In other embodiments, Q⁶ of the structures of formula A1, A2 A3 or B1 is heterocyclyl. In other embodiments, Q⁶ of the structures of formula A1, A2 A3 or B1 is alkylcycloalkyl. In other embodiments, Q⁶ of the structures of formula A1, A2 A3 or B1 is alkylaryl. In other embodiments, Q⁶ of the structures of formula A1, A2 A3 or B1 is alkylheterocyclyl. In other embodiments, Q⁶ of the structures of formula A1, A2 A3 or B1 is halide. In other embodiments, Q⁶ of the structures of formula A1, A2 A3 or B1 is nitro. In other embodiments, Q⁶ of the structures of formula A1, A2 A3 or B1 is amide. In other embodiments, Q⁶ of the structures of formula A1, A2 A3 or B1 is ester. In other embodiments, Q⁶ of the structures of formula A1, A2 A3 or B1 is cyano. In other embodiments, Q⁶ of the structures of formula A1, A2 A3 or B1 is alkoxy. In other embodiments, Q⁶ of the structures of formula A1, A2 A3 or B1 is NH₂. In other embodiments, Q⁶ of the structures of formula A1, A2 or A3 is aminoalkyl. In other embodiments, Q⁶ of the structures of formula A1, A2 A3 or B1 is arylamino. In other embodiments the pyridine ring of the structure of formula A1, A2 A3 or B1 is substituted with 1 to 3 groups of Q⁶ wherein each are independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino.

In some embodiments n, of the structures of formula A1, A2 A3 or B1 is an integer between 1 and 3. In other embodiments n is 1. In other embodiments n is 2. In other embodiments n is 3.

In some embodiments, Q¹ and Q⁵ of the structures of A1, A2 A3 or B1 is the same. In some embodiments Q¹ and Q⁵ of the structures of A1, A2 A3 or B1 is isopropyl. In some embodiments Q³ of the structures of A1, A2 A3 or B1 is isopropyl. In some embodiments Q³ of the structures of A1, A2 A3 or B1 is H. In some embodiments, R¹ and R² of the structures of A1, A2 A3 or B1 is the same. In some embodiments, R¹ and R² of the structures of A1, A2 A3 or B1 is isopropyl. In some embodiments, R¹ and R² of the structures of A1, A2 A3 or B1 is tertbutyl. In some embodiments, R¹ and R² of the structures of A1, A2 A3 or B1 is ethyl. In some embodiments, R¹ and R² of the structures of A1, A2 A3 or B1 is phenyl.

In some embodiments, X¹ and X² of the structure of A3 is the same. In some embodiments, X¹ and X² of the structure of A3 is different. In some embodiments, X¹ and X² of the structure of A3 is Cl. In some embodiments, X¹ and X² of the structure of A3 is Br.

As used herein, the term “alkyl” can be any linear- or branched-chain alkyl group containing up to about 15 carbons unless otherwise specified. In various embodiments, an alkyl includes C₁-C₅ carbons. In some embodiments, an alkyl includes C₁-C₆ carbons. In some embodiments, an alkyl includes C₁-C₈ carbons. In some embodiments, an alkyl includes C₁-C₁₀ carbons. In some embodiments, an alkyl includes C₁-C₁₅ carbons. In some embodiments, branched alkyl is an alkyl substituted by alkyl side chains of 1 to 5 carbons. In various embodiments, the alkyl group may be unsubstituted. In some embodiments, the alkyl group may be substituted by a halide, haloalkyl, hydroxyl, alkoxy, carbonyl, amido, alkylamido, dialkylamido, cyano, nitro, CO₂H, amino, aminoalkyl, diaminoalkyl, carboxyl, thio and/or thioalkyl.

The alkyl group can be a sole substituent or it can be a component of a larger substituent, such as in an alkylcycloalyl, alkylaryl, alkylheterocyclyl, aminoalkyl, alkoxy, etc. Preferred alkyl groups are methyl, ethyl, propyl, isopropyl, tertbutyl and thus methoxy, ethoxy, propoxy, methylamino, ethylamino, propylamino, dimethylamino, diethylamino, isopropylamino, tertbutylamino, methylaryl, ethylaryl, propylaryl, isopropylaryl, tertbutylaryl etc.

A “cycloalkyl” or “carbocyclic” group refers, in various embodiments, to a ring structure comprising carbon atoms as ring atoms, which may be either saturated or unsaturated, substituted or unsubstituted, single or fused. In some embodiments the cycloalkyl is a 3-10 membered ring. In some embodiments the cycloalkyl is a 3-12 membered ring. In some embodiments the cycloalkyl is a 6 membered ring. In some embodiments the cycloalkyl is a 5-7 membered ring. In some embodiments the cycloalkyl is a 3-8 membered ring. In some embodiments the cycloalkyl is a 3-5 membered ring. In some embodiments, the cycloalkyl group may be unsubstituted or substituted by a halogen, alkyl, haloalkyl, hydroxyl, alkoxy, carbonyl, amido, alkylamido, dialkylamido, cyano, nitro, CO₂H, amino, aminoalkyl, diaminoalkyl, carboxyl, thio and/or thioalkyl. In some embodiments, the cycloalkyl ring may be fused to another saturated or unsaturated cycloalkyl or heterocyclic 3-8 membered ring. In some embodiments, the cycloalkyl ring is a saturated ring. In some embodiments, the cycloalkyl ring is an unsaturated ring. Non limiting examples of a cycloalkyl group comprise cyclohexyl, cyclohexenyl, cyclopropyl, cyclopropenyl, cyclopentyl, cyclopentenyl, norbornene, cyclobutyl, cyclobutenyl, cycloctyl, cycloctadienyl (COD), cycloctaene (COE) etc.

A “heterocycle” or “heterocyclyl” group refers, in various embodiments, to a ring structure comprising in addition to carbon atoms, sulfur, oxygen, nitrogen or any combination thereof, as part of the ring. In some embodiments the heterocycle is a 3-10 membered ring. In some embodiments the heterocycle is a 3-12 membered ring. In some embodiments the heterocycle is a 6 membered ring. In some embodiments the heterocycle is a 5-7 membered ring. In some embodiments the heterocycle is a 3-8 membered ring. In some embodiments the heterocycle is a 3-5 membered ring. In some embodiments, the heterocycle group may be unsubstituted or substituted by a halogen, alkyl, haloalkyl, hydroxyl, alkoxy, carbonyl, amido, alkylamido, dialkylamido, cyano, nitro, CO₂H, amino, aminoalkyl, diaminoalkyl, carboxyl, thio and/or thioalkyl. In some embodiments, the heterocycle ring may be fused to another saturated or unsaturated cycloalkyl or heterocyclic 3-8 membered ring. In some embodiments, the heterocyclic ring is a saturated ring. In some embodiments, the heterocyclic ring is an unsaturated ring. Non limiting examples of a heterocyclic rings comprise pyridine, piperidine, morpholine, piperazine, thiophene, pyrrole, benzodioxole, or indole.

As used herein, the term “aryl” refers to any aromatic ring and can be either substituted or unsubstituted. Exemplary aryl groups include, without limitation, phenyl, tolyl, xylyl, furanyl, naphthyl, pyridinyl, pyrimidinyl, pyridazinyl, pyrazinyl, triazinyl, thiazolyl, oxazolyl, isooxazolyl, pyrazolyl, imidazolyl, thiophene-yl, pyrrolyl, phenylmethyl, phenylethyl, phenylamino, phenylamido, etc. Substitutions include but are not limited to: F, Cl, Br, I, C₁-C₅ linear or branched alkyl, C₁-C₅ linear or branched haloalkyl, C₁-C₅ linear or branched alkoxy, C₁-C₅ linear or branched haloalkoxy, CF₃, CN, NO₂, —CH₂CN, NH₂, NH-alkyl, N(alkyl)₂, hydroxyl, —OC(O)CF₃, —OCH₂Ph, —NHCO-alkyl, COOH, —C(O)Ph, C(O)O-alkyl, C(O)H, or —C(O)NH₂.

As used herein, the term “alkylcycloalkyl” refers to an alkyl group as defined above substituted by a cycloalkyl group as defined above. Non limiting examples include: —CH₂-cyclohexyl, —CH₂-cyclohexenyl, —CH₂CH₂-cyclopropyl, —CH₂CH₂cyclopropenyl, etc.

As used herein, the term “alkylaryl” refers to an alkyl group as defined above substituted by an aryl group as defined above. Non limiting examples include: -benzyl (═CH₂Ph), —CH₂-tolyl, —CH₂ pyridinyl —CH₂CH₂phenyl, etc.

As used herein, the term “alkylheterocyclyl” refers to an alkyl group as defined above substituted by a heterocyclyl group as defined above. Non limiting examples include: —CH₂— piperidinyl, —CH₂ thiophenyl, —CH₂ pyridinyl, —CH₂CH₂indolyl, etc.

As used herein, the term “alkoxy” refers to an ether group substituted by an alkyl group as defined above. Alkoxy refers both to linear and to branched alkoxy groups. Nonlimiting examples of alkoxy groups are methoxy, ethoxy, propoxy, iso-propoxy, tert-butoxy.

As used herein, the term “aminoalkyl” refers to an amine group substituted by an alkyl group as defined above. Aminoalkyl refers to monoalkylamine, dialkylamine or trialkylamine. Nonlimiting examples of aminoalkyl groups are —N(Me)₂, —NHMe.

As used herein the term “amide” refers to both “—C(O)—NH—” groups and to “—NH—C(O)—” groups.

As used herein the term “ester” refers to both “—C(O)—O—” groups and to “—O—C(O)—” groups.

As used herein the term “haloalkyl” group refers, In some embodiments, to an alkyl group as defined above, which is substituted by one or more halogen atoms, e.g. by F, Cl, Br or I. Nonlimiting examples of haloalkyl groups are CF₃, CF₂CF₃, CH₂CF₃.

In various embodiments, this invention provides a compound of this invention or its isomer of the complex of this invention. In various embodiments, the term “isomer” includes, but is not limited to, optical isomers and analogs, structural isomers and analogs, conformational isomers and analogs, and the like. In some embodiments, the isomer is an optical isomer. In some embodiment, the isomer is an isotopomer, where deuterium atoms can be used instead of hydrogen atoms. In various embodiments, this invention encompasses the use of various optical isomers of the compounds of the invention.

In some embodiments the iron complexes of the structures of formula A1 are catalysts used for metathesis polymerization of cyclic olefins. In some embodiments the iron complexes of the structures of 9, 10, 11 and 12 are catalysts used for metathesis polymerization of cyclic olefins. In some embodiments the iron complexes of the structures of formula A2 are catalysts used for metathesis polymerization of cyclic olefins.

In some embodiments the iron complex 13 is a catalyst used for metathesis polymerization of cyclic olefins.

In some embodiments, the iron complex of formula A1 in the solid state is in a dimer form represented by the structure of A2.

In some embodiments, the iron complex of formula A3 is a precursor for the preparation of the iron complex of A1.

Preparation of the Iron Complexes of this Invention

In some embodiments the iron complex of A1 is prepared by reacting the corresponding iron complex of A3 with alklyllithium reagents to obtain the corresponding iron complex A1 having SiHₓ(alkyl)_{y}(aryl)_{z} or CHₓ(alkyl)_{y}(aryl)_{z} groups respectively. In other embodiments, the reaction is conducted under inert atmosphere. In other embodiment the solvent is benzene, toluene, xylene, mesitylene, pentane, hexanes, 1,2-difluorobenzene. In other embodiments, the solvent is non-coordinating, and non-chlorinated solvent. In other aprotic.

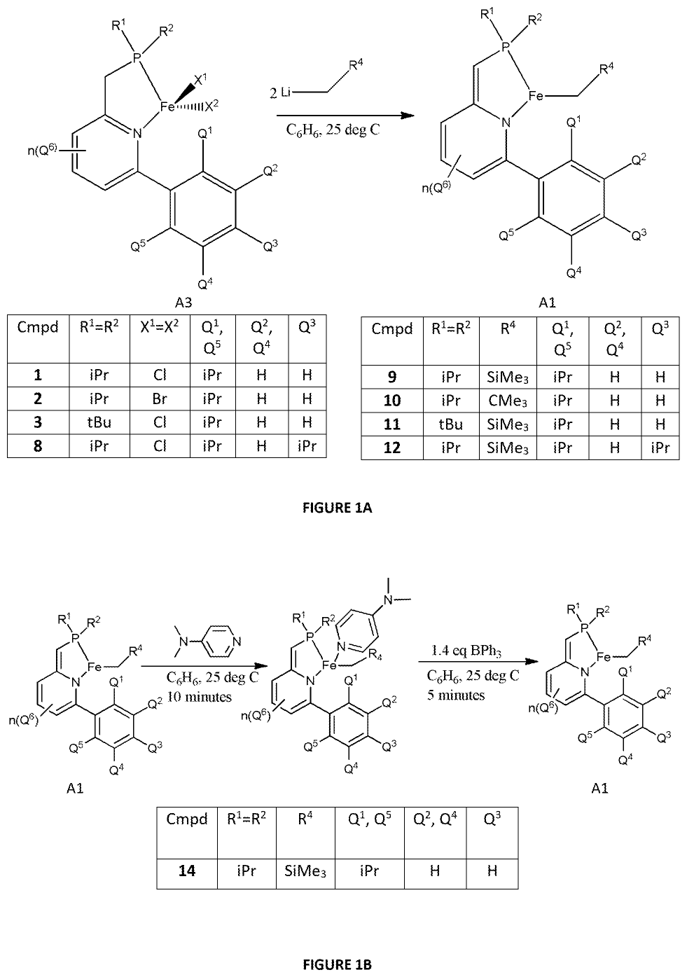

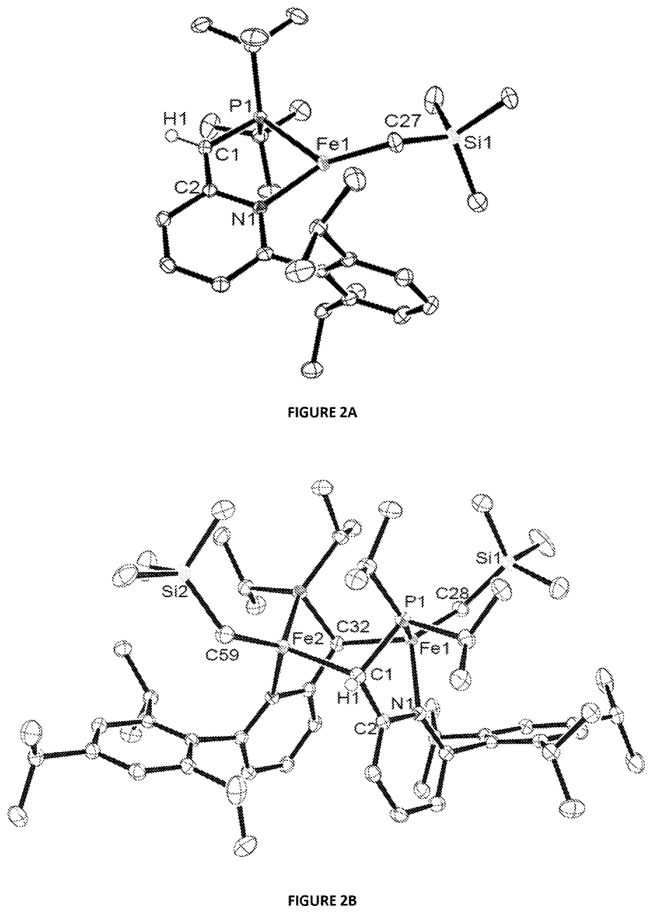

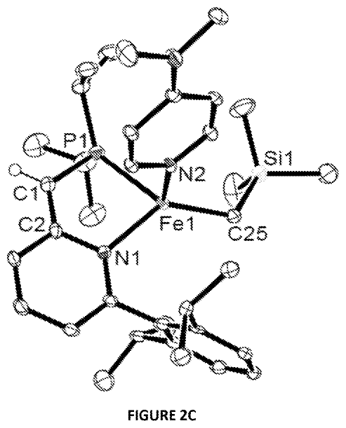

In some embodiments the iron complex of A1 is prepared according to the process presented in FIG. 1A. In other embodiments, the iron complex of A1 is prepared according to the process disclosed in Example 3.

In some embodiment, the dimeric complex of A2 is prepared by precipitation of the iron complex of A1. In some embodiments, the dimeric complex of A2 is prepared by precipitating the iron complex of A1 in pentane or any other aprotic solvent at −30 deg. In some embodiments the iron complexe of A2 is prepared according to the process disclosed in Example 3.

In some embodiments the iron complex of A3 is prepared by reacting the corresponding free ligand with FeX₂ (wherein X is halide) under inert atmosphere. In some embodiments the iron complex of A3 is prepared by reacting the free ligand with FeCl₂ or FeBr₂ under inert atmosphere. In some embodiments the iron complex of A3 is prepared according to the process disclosed in Example 4.

### Metathesis Polymerization of Cyclic Olefins

In some embodiments, this invention is directed to a method for metathesis polymerization of cyclic olefins comprising reacting a substituted or unsubstituted cyclic olefin with the iron complex of formula A1 or A2, thereby obtaining a polymer by ring opening metathesis polymerization. In another embodiment, the polymer is polycyclic. In other embodiment, complexes A1 and A2 are used as isolated complexes or prepared in solution without isolation. In other embodiments, the iron complex of formula A1 or A2 is a complex of structure 9, 10, 11, 12 or 13. Each represents a separate embodiment of this invention.

In one embodiment, this invention provides iron-catalyzed ROMP (=ring-opening metathesis polymerization) of norbornene and its derivatives utilizing the pyridine-based ligand of structures A1 or A2.

In one embodiment, this invention provides iron-catalyzed ROMP (=ring-opening metathesis polymerization) of cyclic olefins and its derivatives utilizing the pyridine-based ligand of structures A1 or A2.

ROMP is one of the largest scale applications of the olefin metathesis reaction in the chemical industry.

Not being bound to any mechanism, in one embodiment, the metathesis polymerization of this invention includes α-hydrogen elimination from a coordinated unsaturated iron(II)-alkyl complex leading to an iron-carbene complex, which may coordinate olefins and catalyzes metathesis reactions.

As used herein the term “cyclic olefin” refers, in various embodiments, to a ring structure comprising carbon atoms as ring atoms (carbocycle), or a ring structure comprising in addition to carbon atoms, sulfur, oxygen, nitrogen or any combination thereof, as part of the ring carbon atoms (heterocycle); having at least one double bond; which may be substituted or unsubstituted, single or fused. In other embodiments the cyclic olefin includes one double bone. In other embodiments the cyclic olefin includes a diene. In other embodiments, the cyclic olefin of this invention is a strained ring. In other embodiments the cyclic olefin is a norbornene, bicycle ring or a 3, 4 or 5 membered ring. Non limiting examples of cyclic olefins include: cyclopropene, cyclobutene, cyclopentene, cyclohexene, norbornene. In other embodiments, the cyclic olefin is unsubstituted. In other embodiments, the cyclic olefin is substituted by a halogen, alkyl, Si(alkyl)₃, haloalkyl, hydroxyl, alkoxy, carbonyl, amido, alkylamido, dialkylamido, cyano, nitro, CO₂H, amino, aminoalkyl, diaminoalkyl, carboxyl, thio and/or thioalkyl.

In some embodiments, this invention is directed to a method for metathesis polymerization of cyclic olefins comprising reacting a substituted or unsubstituted cyclic olefin with the iron complex of formula A1 or A2 as a catalyst. In other embodiments, the iron catalyst being used is between 0.02 mol % to 2 mol % per cyclic olefin. In other embodiments, the iron catalyst being used is between 0.2 mol % to 1 mol % per cyclic olefin. In other embodiments, the iron catalyst being used is between 0.5 mol % to 1.5 mol % per cyclic olefin.

In some embodiment, the metathesis polymerization reaction of this invention is conducted under inert atmosphere. In other embodiment, the metathesis polymerization of this invention is conducted under nitrogen (N₂). In other embodiment, the metathesis polymerization of this invention is conducted under Argon (Ar).

In some embodiment, the method of the metathesis polymerization of this invention further includes addition of less than 1 equivalent of water per iron. In other embodiment, 0.01 to 0.99 equivalents of water (per iron) are added to the reaction mixture. In other embodiment, 0.1 to 0.9 equivalents of water (per iron) are added to the reaction mixture. In other embodiment, 0.2 to 0.9 equivalents of water (per iron) are added to the reaction mixture. In other embodiment, 0.3 to 0.9 equivalents of water (per iron) are added to the reaction mixture. In other embodiment, 0.4 to 0.9 equivalents of water (per iron) are added to the reaction mixture. In other embodiment, 0.5 to 0.9 equivalents of water (per iron) are added to the reaction mixture.

In some embodiment, the method of the metathesis polymerization of this invention is conducted in an aprotic solvent. In other embodiments, the solvent is benzene, toluene, xylene, mesitylene, pentane, hexanes, 1,2-difluorobenzene. In other embodiments, the solvent is non-coordinating, and non chlorinated solvent.

In some embodiments, the method of this invention includes a method for the preparation of a polymer by ring opening metathesis polymerization by metathesis polymerization using iron complexes A1 or A2 of this invention. In another embodiment, the polymer product is polycyclic.

As used herein the term “polycyclic polymer” refers, in various embodiments, to a polymer comprising a cyclic ring (substituted or unsubstituted) as the monomeric unit. In other embodiment, the polycyclic polymer comprises a monomeric unit comprising a ring opening of the corresponding cyclic olefin used as the starting material.

In some embodiments, the method of metathesis polymerization using substituted or unsubstituted norbornene as a starting material is presented by the following scheme:

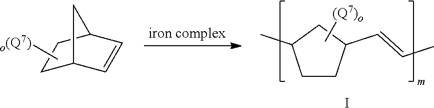

wherein Q⁷ is independently H, linear or branched alkyl, aryl, heterocyclyl, alkylcycloalkyl, alkylaryl, alkylheterocyclyl, Si(alkyl)3, halide, nitro, amide, ester, cyano, alkoxy, NH₂, aminoalkyl or arylamino;
o is an integer between 1-3;
m is an integer larger than 2.

In some embodiments Q⁷ of formula I, Va-Vd or of the norbornene ring is H. In other embodiments Q⁷ of formula I, Va-Vd or of the norbornene ring is linear or branched alkyl. In other embodiments Q⁷ of formula I, Va-Vd or of the norbornene ring is aryl. In other embodiments Q⁷ of formula I, Va-Vd or of the norbornene ring is heterocyclyl. In other embodiments Q⁷ of formula I, Va-Vd or of the norbornene ring is alkylcycloalkyl. In other embodiments Q⁷ of formula I or of the norbornene ring is alkylaryl. In other embodiments Q⁷ of formula I, Va-Vd or of the norbornene ring is alkylheterocyclyl. In other embodiments Q⁷ of formula I, Va-Vd or of the norbornene ring is Si(alkyl)₃. In other embodiments Q⁷ of formula I, Va-Vd or of the norbornene ring is halide. In other embodiments Q⁷ of formula I, Va-Vd or of the norbornene ring is nitro. In other embodiments Q⁷ of formula I, Va-Vd or of the norbornene ring is amide. In other embodiments Q⁷ of formula I, Va-Vd is ester. In other embodiments Q⁷ of formula I, Va-Vd or of the norbornene ring is cyano. In other embodiments Q⁷ of formula I, Va-Vd or of the norbornene ring is alkoxy. In other embodiments Q⁷ of formula I, Va-Vd or of the norbornene ring is NH₂. In other embodiments Q⁷ of formula I, Va-Vd or of the norbornene ring is aminoalkyl. In other embodiments Q⁷ of formula I, Va-Vd or of the norbornene ring is arylamino. In other embodiments the norborene ring and the cyclopentane ring of the structure of I, Va-Vd is substituted with 1 to 3 groups of Q⁷ wherein each are independently H, linear or branched alkyl, aryl, heterocyclyl, alkylcycloalkyl, alkylaryl, alkylheterocyclyl, Si(alkyl)3, halide, nitro, amide, ester, cyano, alkoxy, NH₂, aminoalkyl or arylamino.

In some embodiments, o of formula I, Va-Vd is an integer 1. In other embodiments o is an integer 2. In other embodiments o is an integer 3.

In some embodiments m refers to the number of monomeric units in the polymers obtained according to this invention. In some embodiments m is an integer larger than 2. In some embodiments m is an integer between 2 to 1,000,000. In other embodiments m is an integer between 50-1000. In other embodiments m is an integer between 1,000 to 200,000. In other embodiments m is an integer between 1,000 to 500,00000. In other embodiments m is an integer between 1,000 to 700,000. In other embodiments m is an integer between 100 to 1,000,000. In other embodiments m is an integer between 10,000 to 1,000,000. In other embodiments m is an integer between 100,000 to 1,000,000.

In other embodiments, the polynorbornene of formula I has a molecular weight larger than 10⁷ g/mol. In some embodiments, the polynorbornene of formula I has a molecular weight of about 4,000,000 g/mol. In some embodiments, the polynorbornene of formula I has a molecular weight larger than 4,000,000 g/mol.

In some embodiments, the polycyclic polymer of formula I is a highly stereoregular ROMP polymer. In other embodiments, the polycyclic polymer of formula I is a trans-isotactic polynorbornene (substituted or unsubstituted).

In some embodiments substituted or unsubstituted polynorbornene prepared by the method of this invention (without addition of another olefin to the reaction mixture) is represented by the structure of formula I has hydrogen (H) as terminal end group.

In some embodiments, the metathesis polymerization of this invention comprises reacting a cyclic olefin and an olefin (R—CH═CH₂ wherein R is substituted or unsubstituted-aryl, phenyl, herteroaryl, alkyl, cycloalkyl or heterocycloalkyl) in the presence of the iron complex of this invention to obtain a polymer (by ring opening metathesis polymerization) having inter alia a terminal R group. In some embodiments, the olefin (R—CH═CH₂) is added in an equimolar amount of the cyclic olefin. In some embodiments, the olefin (R—CH═CH₂) itself does not undergo polymerization.

In some embodiments, the method of metathesis polymerization of the invention is conducted in the presence of styrene. In some embodiments, the styrene is in an equimolar amount of the cyclic olefin. In some embodiments, the styrene itself does not undergo polymerization.

In some embodiments, in the presence of styrene, the method of the invention produces a ring opening metathesis polymerization that is soluble in an organic solvent (having inter alia a terminal CH-Ph group). In some embodiments, the organic solvent is chloroform. In other embodiments, the organic solvent is benzene.

In some embodiments, in the presence of styrene, the method of the invention produces a ring opening metathesis polymerization capped by PhCH. In some embodiments, the ring opening metathesis polymerization has the end (terminal) groups of PhCH.

In some embodiments, a reaction between norbornene and styrene, produces a polycyclic polymer comprising at least one of I, Va, Vb, Vc, Vd or combination thereof:

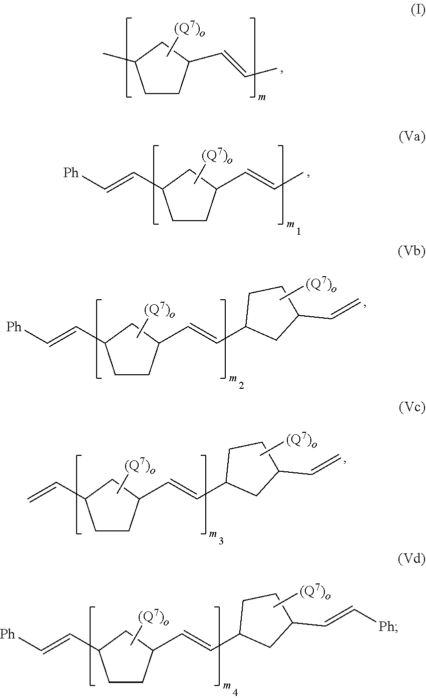

wherein m₁, m₂, m₃, and m₄ are each an integer of 2-1,000,000; Q⁷ is independently H, linear or branched alkyl, aryl, heterocyclyl, alkylcycloalkyl, alkylaryl, alkylheterocyclyl, Si(alkyl)3, halide, nitro, amide, ester, cyano, alkoxy, NH₂, aminoalkyl or arylamino; and
is an integer between 1-3.

In some embodiments, the molecular weight of compound Va-Vd is between 15,000 g/mol and 50,000 g/mol. In some embodiments, the molecular weight of compound Va-Vd is greater than 23,000 g/mol. In some embodiments, the molecular weight of compound Va-Vd is between 23,000 g/mol and 32,000 g/mol. In some embodiments, the molecular weight of compound Va-Vd is about 16,000 g/mol. In some embodiments, the molecular weight of compound Va-Vd is greater than 16,000 g/mol. In some embodiments, the molecular weight of compound of Va-Vd is about 46,000 g/mol. In some embodiments, the molecular weight of compound of Va-Vd is larger than 46,000 g/mol. In some embodiments, the molecular weight of compound Va-Vd is about 32,000 g/mol. In some embodiments, the molecular weight of compound Va-Vd is greater than 32,000 g/mol.

In some embodiments, m₁ is an integer of 2-1,000,000. In other embodiments, m₁ is an integer of 50-1000. In some embodiments, m₁ is an integer of 1,000-200,000. In some embodiments, m₁ is an integer of 1,000-500,00000. In some embodiments, m₁ is an integer of 1,000-700,000. In some embodiments, m₁ is an integer of 100-1,000,000. In some embodiments, m₁ is an integer of 10,000-1,000,000. In some embodiments, m₁ is an integer of 100,000-1,000,000.

In some embodiments, m₂ is an integer of 2-1,000,000. In other embodiments, m₂ is an integer of 50-1000. In some embodiments, m₂ is an integer of 1,000-200,000. In some embodiments, m₂ is an integer of 1,000-500,00000. In other embodiments, m₂ is an integer of 1,000-700,000. In some embodiments, m₂ is an integer of 100-1,000,000. In some embodiments, m₂ is an integer of 10,000-1,000,000. In some embodiments, m₂ is an integer of 100,000-1,000,000.

In some embodiments, m₃ is an integer of 2-1,000,000. In other embodiments, m₃ is an integer of 50-1000. In some embodiments, m₃ is an integer of 1,000-200,000. In some embodiments, m₃ is an integer of 1,000-500,00000. In some embodiments, m₃ is an integer of 1,000-700,000. In some embodiments, m₃ is an integer of 100-1,000,000. In some embodiments, m₃ is an integer of 10,000-1,000,000. In other embodiments, m₃ is an integer of 100,000-1,000,000.

In some embodiments, m₄ is an integer of 2-1,000,000. In other embodiments, m₄ is an integer of 50-1000. In some embodiments, m₄ is an integer of 1,000-200,000. In some embodiments, m₄ is an integer of 1,000-500,00000. In other embodiments, m₄ is an integer of 1,000-700,000. In some embodiments, p is an integer of 100-1,000,000. In some embodiments, m₄ is an integer of 10,000-1,000,000. In some embodiments, m₄ is an integer of 100,000-1,000,000.

In one embodiment, the terms “about”, “approximately” or the symbol “˜” may comprise a deviance from the indicated term of +1%, or in some embodiments, −1%, or in some embodiments, ±2.5%, or in some embodiments, ±5%, or in some embodiments, ±7.5% or in some embodiments, ±10%, or in some embodiments.

The following examples are presented in order to more fully illustrate the preferred embodiments of the invention. They should in no way, however, be construed as limiting the broad scope of the invention.

### EXAMPLES

### Example 1

### Preparation of PN Ligands

“PN ligands” in this invention refers to ligands comprising phosphorus and nitrogen atoms that bind the iron.

2-(2,6-diisopropylphenyl)-6-methylpyridine. [F. Speiser, P. Braunstein, L. Saussine, Organometallics 23, 2633 (2004)]

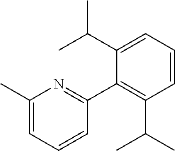 [SMILES: Cc1cccc(-c2c(C(C)C)cccc2C(C)C)n1]

The titled compound was prepared using a modified literature procedure [R. R. Schrock, J. D. Fellmann, J. Am. Chem. Soc. 100, 3359 (1978)]. In a nitrogen glove box, a 100 mL Schlenk flask equipped with a Teflon coated stirring bar was charged with Ni(acac)₂ (256.6 mg, 1.0 mmol), 2-bromo-6-methylpyridine (3.4511 g, 20.0 mmol), 1,3-bis(2,4,6-trimethylphenyl)-4,5-dihydroimidazolinium chloride (346.4 mg, 1.0 mmol), and 20 mL THF. Using Schlenk technique outside the box, to the green solution was then added 2,6-diisopropylphenylmagnesium bromide (prepared using 1-bromo-2,6-diisopropylbenzene (7.2721 g, 30.0 mmol) and magnesium (1.4553 g, 59.9 mmol) in 20 mL THF) using extra 10 mL THF to transfer the solution quantitatively. The reaction mixture was then stirred for 16 h at r.t., quenched using 10 mL methanol, and concentrated. The organic compounds were then extracted from the resulting solid using ether. The collected ether solution was concentrated, and purified by column chromatography (SiO₂, hexanes: ethyl acetate=20:1). The product was obtained as a yellow crystalline solid, 3.5822 g, 70% yield.

### 2-(2,4,6-trimethylphenyl)-6-methylpyridine

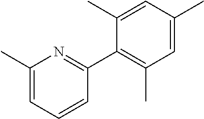

In a nitrogen glove box, a 100 mL Schlenk flask equipped with a Teflon coated stirring bar was charged with Ni(acac)₂ (127.2 mg, 0.5 mmol), 2-bromo-6-methylpyridine (3.466 g, 20.1 mmol), 1,3-bis(2,4,6-trimethylphenyl)-4,5-dihydroimidazolinium chloride (170.1 mg, 0.5 mmol), and 10 mL THF. Using Schlenk technique outside the box, to the green solution was then added 2,4,6-trimethylphenylmagnesium bromide (prepared using 1-bromo-2,4,6-trimethylbenzene (5.903 g, 29.6 mmol) and magnesium (1.4872 g, 61.1 mmol) in 20 mL THF) using extra 10 mL THF to transfer the solution quantitatively. The reaction mixture was then stirred for 4 h at r.t., quenched using 10 mL methanol, and concentrated. The organic compounds were then extracted from the resulting solid using ether. The collected ether solution was concentrated. The product was obtained as a yellow oil, 4.52 g, quantitative yield. Known compound. Reference: H.-P. Chen, Y.-H. Liu, S.-M. Peng, and S.-T. Liu, Organometallics 22, 4893 (2003).

### 2-(2,4,6-triisopropylphenyl)-6-methylpyridine

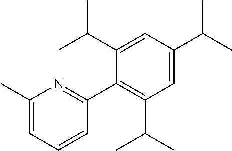 [SMILES: Cc1cccc(-c2c(C(C)C)cc(C(C)C)cc2C(C)C)n1]

In a nitrogen glove box, a 250 mL Schlenk flask equipped with a Teflon coated stirring bar was charged with Ni(acac)₂ (128 mg, 0.5 mmol), 2-bromo-6-methylpyridine (1.72 g, 10.0 mmol), 1,3-bis(2,4,6-trimethylphenyl)-4,5-dihydroimidazolinium chloride (171 mg, 0.5 mmol), and 5 mL THF. Using Schlenk technique outside the box, to the green solution was then added 2,4,6-triisopropylphenylmagnesium bromide (prepared using 1-bromo-2,4,6-triisopropylbenzene (4.25 g, 15.0 mmol) and magnesium (0.725 g, 30.0 mmol) in 7 mL THF) using extra 8 mL THF to transfer the solution quantitatively. The reaction mixture was then stirred for 16 h at r.t., quenched using 5 mL methanol, and concentrated. The organic compounds were then extracted from the resulting solid using ether. The collected ether solution was concentrated, and purified by column chromatography (SiO₂, eluted first using hexanes to remove 2,4,6-triisopropylbenzene, then using dichloromethane to elute the product crystallized on the column). The product was obtained as a off-white crystalline solid, 1.3569 g, 46% yield.

¹H NMR (500.08 MHz, CDCl₃, 298 K): δ 1.08 (6H, d, ³J_{HH}=7.0 Hz, 2,6-CH(CH₃)₂), 1.12 (6H, d, ³J_{HH}=6.5 Hz, 2,6-CH(CH₃)₂), 1.26 (6H, d, ³J_{HH}=7.0 Hz, 4-CH(CH₃)₂), 2.50 (2H, septet, ³J_{HH}=7.1 Hz, 2,6-CH(CH₃)₂), 2.59 (3H, s, CH₃), 2.91 (1H, septet, ³J_{HH}=6.8 Hz, 4-CH(CH₃)₂), 7.05 (2H, s, aromatic 2CH), 7.08 (1H, overlapping d, ³J_{HH}=7.5 Hz, aromatic CH), 7.10 (1H, overlapping d, ³J_{HH}=8.0 Hz, aromatic CH), 7.60 (1H, t, ³J_{HH}=7.5 Hz, aromatic CH).

¹³C{¹H}NMR (125.75 MHz, CDCl₃, 298 K): δ 23.8 (s, 2,6-CH(CH₃)₂), 24.1 (s, 2,6-CH(CH₃)₂), 24.4 (s, 4-CH(CH₃)₂), 24.6 (s, CH₃), 30.3 (s, 2,6-CH(CH₃)₂), 34.5 (s, 4-CH(CH₃)₂), 120.7 (s, 2 aromatic CH), 120.8 (s, aromatic), 121.9 (s, aromatic), 135.8 (s, aromatic), 136.6 (s, aromatic, ipso), 146.1 (s, 2 aromatic ipso CH), 148.6 (s, aromatic ipso), 157.8 (s, aromatic, ipso), 159.4 (s, aromatic, ipso).

HRMS (ESI⁺) m/z caled for C₂₄H₃₇NP⁺ ([M+H]⁺): 296.2378. Found: 296.2391.

### 2-(2,6-diisopropylphenyl)-6-(diisopropylphophinomethyl)pyridine (20, PNdipp-ⁱPr)

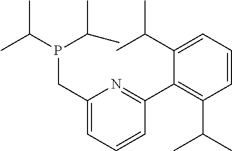 [SMILES: CC(C)c1cccc(C(C)C)c1-c1cccc(CP(C(C)C)C(C)C)n1]

In a nitrogen glove box, a 20 mL vial equipped with a Teflon coated stirring bar was charged with 2-(2,6-diisopropylphenyl)-6-methylpyridine (synthesis described above; 503.9 mg, 1.99 mmol) and 6 mL THF. The clear faint yellow solution was cooled to −35° C. To the cold solution was added 1.6 M ⁿBuLi in hexanes (1.3 mL, 2.08 mmol) dropwise. The dark red solution was stirred at r.t. for 5.5 h, and cooled to −35° C. To the solution was then added chlorodiisopropylphosphine (306.8 mg, 2.01 mmol) in 3 mL THF. The solution was stirred for 16 h at r.t., quenched by 1 mL methanol, and concentrated. The product was extracted from the resulting solid using n-pentane. Concentration of the pentane extract gave PNdipp-ⁱPr as an off-white solid. Yield: 717.1 mg, 98%.

¹H NMR (400.36 MHz, CDCl₃, 291 K): δ 1.06 (18H, overlapping d, 2PCH(CH₃)₂ and CH(CH₃)₂), 1.12 (6H, d, ³J_{HH}=6.9 Hz, CH(CH₃)₂), 1.83 (2H, septet, ³J_{HH}=7.1 Hz, ²J_{HP}=1.6 Hz, 2PCH(CH₃)₂), 2.52 (2H, septet, ³J_{HH}=6.9 Hz, 2CH(CH₃)₂), 3.07 (2H, d, ²J_{HP}=2.2 Hz, CH₂), 7.02 (1H, d, ³J_{HH}=7.5 Hz, aromatic CH), 7.19 (2H, d, ³J_{HH}=7.7 Hz, aromatic 2CH), 7.32 (1H, d, ³J_{HH}=7.7 Hz, aromatic CH), 7.37 (1H, d, ³J_{HH}=7.9 Hz, aromatic CH), 7.62 (1H, t, ³J_{HH}=7.8 Hz aromatic CH).

¹³C{¹H}NMR (100.67 MHz, CDCl₃, 291 K): δ 19.0 (d, ²J_{CP}=9.8 Hz, PCH(CH₃)₂), 19.8 (d, ²J_{CP}=15.1 Hz, PCH(CH₃)₂), 23.7 (d, J_{CP}=13.8 Hz, 2PCH(CH₃)₂), 23.8 (s, CH(CH₃)₂), 24.3 (s, CH(CH₃)₂), 30.2 (s, 2CH(CH₃)₂), 32.5 (d, ¹J_{CP}=21.0 Hz, CH₂), 121.6 (d, ³J_{CP}=8.9 Hz, aromatic), 121.8 (s, aromatic), 122.6 (s, 2 aromatic CH), 128.3 (s, aromatic), 135.6 (s, aromatic), 139.0 (s, aromatic, ipso), 146.4 (s, 2 aromatic ipso C), 159.0 (s, aromatic, ipso), 160.4 (d, ²J_{CP}=9.8 Hz, aromatic, ipso).

³¹P{¹H}NMR (121.50 MHz, CDCl₃, 291 K): δ 13.5.

HRMS (ESI⁺) m/z caled for C₂₄H₃₇NP⁺ ([M+H]⁺): 370.2664. Found: 370.2663.

### 2-(2,6-diisopropylphenyl)-6-(di-tert-butylphophinomethyl)pyridine (21, PNdipp-^{t}Bu)

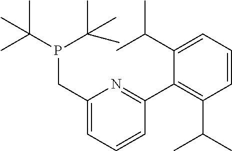 [SMILES: CC(C)c1cccc(C(C)C)c1-c1cccc(CP(C(C)(C)C)C(C)(C)C)n1]

In a nitrogen glove box, a 20 mL vi equipped with a Teflon coated stirring bar was charged with 2-(2,6-diisopropylphenyl)-6-methylpyridine (synthesis described above; 506.5 mg, 2.00 mmol) and 4 mL THF. The clear faint yellow solution was cooled to −35° C. To the cold solution was added 1.6 M ⁿBuLi in hexanes (1.3 mL, 2.08 mmol) dropwise. The dark red solution was stirred at r.t. for 4 h, and cooled to −35° C. To the solution was then added di-tert-butylchlorophosphine (378.5 mg, 2.10 mmol) in 3 mL THF. The solution was stirred for 10 h at r.t., quenched by 1 mL methanol, and concentrated. The product was extracted from the resulting solid using n-pentane. Concentration of the pentane extract gave PNdipp-^{t}Bu as an off-white solid. Yield: 735.7 mg, 93%.

¹H NMR (300.13 MHz, CDCl₃, 291 K): δ 1.05 (6H, d, ³J_{HH}=6.9 Hz, CH(CH₃)₂), 1.11 (6H, d, ³J_{HH}=6.8 Hz, CH(CH₃)₂), 1.16 (18H, d, ³J_{HP}=14.0 Hz, 2PC(CH₃)₃), 2.51 (2H, septet, ³J_{HH}=6.9 Hz, 2CH(CH₃)₂), 3.13 (2H, d, ²J_{HP}=3.6 Hz, CH₂), 7.01 (1H, d, ³J_{HH}=7.5 Hz, aromatic CH), 7.19 (2H, m, aromatic 2CH), 7.33 (2H, dd, J=8.4, 7.1 Hz, aromatic CH), 7.52 (1H, br d, ³J_{HH}=7.7 Hz, aromatic CH), 7.62 (1H, pseudo t, aromatic CH).

¹³C{¹H}NMR (100.67 MHz, CDCl₃, 291 K): δ 23.7 (s, CH(CH₃)₂), 24.4 (s, CH(CH₃)₂), 29.6 (d, ²J_{CP}=13.1, 2PC(CH₃)₃), 30.1 (s, 2CH(CH₃)₂), 31.9 (d, ¹J_{CP}=21.0 Hz, 2PC(CH₃)₃), 31.9 (d, J_{CP}=23.4 Hz, CH₂), 121.7 (s, aromatic), 121.9 (d, ³J_{CP}=11.6 Hz, aromatic), 122.6 (s, 2 aromatic CH), 128.3 (s, aromatic), 135.6 (s, aromatic), 139.0 (s, aromatic, ipso), 146.4 (s, 2 aromatic ipso C), 158.7 (s, aromatic, ipso), 161.7 (d, ²J_{CP}=15.1 Hz, aromatic, ipso).

³¹P{¹H}NMR (121.50 MHz, CDCl₃, 291 K): δ 37.2.

HRMS (ESI⁺) m/z calcd for C₂₆H₄₁NP⁺ ([M+H]⁺): 398.2977. Found: 398.2980.

### 2-(2,6-diisopropylphenyl)-6-(diethylphophinomethyl)pyridine (22, PNdipp-Et)

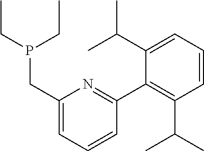 [SMILES: CCP(CC)Cc1cccc(-c2c(C(C)C)cccc2C(C)C)n1]

In a nitrogen glove box, a 20 mL vial equipped with a Teflon coated stirring bar was charged with 2-(2,6-Diisopropylphenyl)-6-methylpyridine (synthesis described above; 255.1 mg, 1.01 mmol) and 2 mL THF. The clear faint yellow solution was cooled to −35° C. To the cold solution was added 1.6 M ⁿBuLi in hexanes (0.65 mL, 2.04 mmol) dropwise. The dark red solution was stirred at r.t. for 5 h, and cooled to −35° C. To the solution was then added chlorodiethylphosphine (126.0 mg, 1.01 mmol) in 3 mL THF. The solution was stirred for 16 h at r.t., quenched by 1 mL methanol, and concentrated. The product was extracted from the resulting solid using n-pentane. Concentration of the pentane extract gave PNdipp-Et as an off-white solid. Yield: 353.6 mg, quantitative yield.

¹H NMR (400.36 MHz, C₆D₆, 299 K): δ 0.99 (6H, dt, ³J_{HH}=7.6 Hz, ²J_{HP}=7.7 Hz, P(CH₂CH₃)₂), 1.12 (6H, d, ³J_{HH}=6.8 Hz, CH(CH₃)₂), 1.21 (6H, d, ³J_{HH}=6.8 Hz, CH(CH₃)₂), 1.30 (4H, q, ³J_{HH}=7.6 Hz, P(CH₂CH₃)₂), 1.35 (4H, q, ³J_{HH}=7.6 Hz, P(CH₂CH₃)₂), 2.74 (2H, septet, ³J_{HH}=6.8 Hz, 2CH(CH₃)₂), 3.00 (2H, s, CH₂), 6.86 (2H, overlapping two d, ³J_{HH}=7.7 Hz and ³J_{HH}=7.6 Hz, aromatic 2CH), 7.12 (1H, t, ³J_{HH}=7.7 Hz, aromatic CH), 7.21 (2H, d, ³J_{HH}=7.8 Hz, aromatic 2CH), 7.34 (1H, pseudo t, aromatic CH).

¹³C{¹H}NMR (100.67 MHz, C₆D₆, 299 K): δ 10.0 (d, ²J_{CP}=14.5 Hz, P(CH₂CH₃)₂), 19.3 (d, ¹J_{CP}=14.7 Hz, P(CH₂CH₃)₂), 24.2 (s, CH(CH₃)₂), 24.5 (s, CH(CH₃)₂), 30.8 (s, 2CH(CH₃)₂), 36.7 (d, ¹J_{CP}=20.4 Hz, CH₂), 121.7 (d, ³J_{CP}=4.7 Hz, aromatic), 121.8 (s, aromatic), 122.9 (s, 2 aromatic CH), 128.8 (s, aromatic), 135.7 (s, aromatic), 139.8 (s, aromatic, ipso), 146.8 (s, 2 aromatic ipso C), 159.4 (d, ²J_{CP}=3.9 Hz, aromatic), 160.0 (s, aromatic, ipso).

³¹P{¹H}NMR (162.07 MHz, C₆D₆, 299 K): δ −14.3.

HRMS (ESI⁺) m/z calcd for C₂₂H₃₂NPNa⁺ ([M+Na]⁺): 364.2170. Found: 364.2170.

### 2-(2,6-diisopropylphenyl)-6-(diethylphophinomethyl)pyridine (PNdipp-Ph)

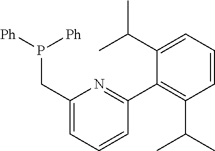 [SMILES: CC(C)c1cccc(C(C)C)c1-c1cccc(CP(c2ccccc2)c2ccccc2)n1]

In a nitrogen glove box, a 20 mL vial equipped with a Teflon coated stirring bar was charged with 2-(2,6-Diisopropylphenyl)-6-methylpyridine (synthesis described above; 127.0 mg, 0.50 mmol) and 5 mL ether. The clear faint yellow solution was cooled to −35° C. To the cold solution was added 1.6 M ⁿBuLi in hexanes (0.32 mL, 0.51 mmol) dropwise. The dark red solution was stirred at r.t. for 1 h, and cooled to −35° C. To the solution was then added diphenylchlorophosphine (111.3 mg, 0.50 mmol) in 2 mL ether. The solution was stirred for 30 min at r.t., quenched by 0.5 mL methanol, and concentrated. The product was extracted using n-pentane. Concentration of the pentane extract gave PNdipp-Ph as a colorless oil. Yield: 224.0 mg, quantitative yield. Known compound. Reference: F. Speiser, P. Braunstein, L. Saussine, Organometallics 23, 2633 (2004).

### 2-(2,6-diisopropylphenyl)-6-[1-(diisopropylphophino)-1,1-dimethylethyl]pyridine (23, PNdipp-ⁱPr-Me₂)

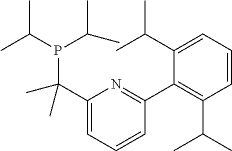 [SMILES: CC(C)c1cccc(C(C)C)c1-c1cccc(C(C)(C)P(C(C)C)C(C)C)n1]

In a nitrogen glove box, a 20 mL vial equipped with a Teflon coated stirring bar was charged with PNdipp-ⁱPr (synthesis described above; 184.1 mg, 0.498 mmol) trimethylsilylmethyllithium (48.1 mg, 0.511 mmol), and 7 mL ether. The dark red solution was stirred at r.t. for 15 min. To the solution was added MeI (31 μL, 0.498 mmol), and the solution was stirred at r.t. for 15 min. Trimethylsilylmethyllithium (47.3 mg, 0.502 mmol) was then added again. The dark red solution was stirred at r.t. for 15 min. To the solution was then added MeI (31 μL, 0.498 mmol). The solution was stirred at r.t. for 15 min, quenched by 0.5 mL methanol, and concentrated. The product was extracted from the resulting solid using n-pentane. Concentration of the pentane extract gave PNdipp-ⁱPr-Me₂ as a faint yellow solid. Yield: 186.0 mg, 94%.

¹H NMR (400.36 MHz, CDCl₃, 291 K): δ 0.95 (6H, dd, ³J_{HH}=7.0 Hz, ³J_{HP}=10.3 Hz, PCH(CH₃)₂), 1.11 (6H, dd, ³J_{HH}=7.2 Hz, ³J_{HP}=14.2 Hz, PCH(CH₃)₂), 1.14 (6H, d, ³J_{HH}=6.9 Hz, CH(CH₃)₂), 1.23 (6H, d, ³J_{HH}=6.9 Hz, CH(CH₃)₂), 1.63 (6H, d, ³J_{HP}=9.6 Hz, 2CH₃), 1.81(2H, d septet, ³J_{HH}=7.0 Hz, ²J_{HP}=4.2 Hz, 2PCH(CH₃)₂), 2.73 (2H, septet, ³J_{HH}=6.8 Hz, 2CH(CH₃)₂), 6.82 (1H, d, ³J_{HH}=7.6 Hz, aromatic CH), 7.16 (1H, overlapping with a residual C₆D₆ peak, aromatic CH), 7.21 (2H, d, ³J_{HH}=7.6 Hz, aromatic 2CH), 7.34 (2H, m, aromatic 2CH).

¹³C{¹H}NMR (100.67 MHz, C₆D₆, 298 K): δ 20.4 (d, ²J_{CP}=10.0 Hz, PCH(CH₃)₂), 22.7 (d, ¹J_{CP}=23.3 Hz, 2PCH(CH₃)₂), 23.4 (d, ²J_{CP}=22.0 Hz, PCH(CH₃)₂), 24.2 (s, CH(CH₃)₂), 24.8 (s, CH(CH₃)₂), 27.5 (d, ²J_{CP}=12.7 Hz, 2CH₃), 30.8 (s, 2CH(CH₃)₂), 41.3 (d, ¹J_{CP}=24.5 Hz, C(CH₃)₂), 120.2 (d, ³J_{CP}=9.5 Hz, aromatic), 121.6 (s, aromatic), 123.0 (s, 2 aromatic CH), 128.8 (s, aromatic), 135.4 (s, aromatic), 139.9 (s, aromatic, ipso), 146.8 (s, 2 aromatic ipso C), 158.7 (s, aromatic, ipso), 167.5 (d, ²J_{CP}=6.0 Hz, aromatic).

³¹P{¹H}NMR (162.07 MHz, C₆D₆, 298 K): δ 43.7.

HRMS (ESI⁺) m/z calcd for C₂₆H₄₁NP⁺ ([M+H]⁺): 398.2977. Found: 398.2970.

### 2-(2,4,6-trimethylphenyl)-6-(diisopropylphophinomethyl)pyridine (24, PNmes-ⁱPr)

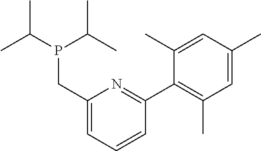 [SMILES: Cc1cc(C)c(-c2cccc(CP(C(C)C)C(C)C)n2)c(C)c1]

In a nitrogen glove box, a 20 mL vial equipped with a Teflon coated stirring bar was charged with 2-(2,4,6-trimethylphenyl)-6-methylpyridine (synthesis described above; 216.8 mg, 1.0 mmol) and 5 mL THF. The clear faint yellow solution was cooled to −35° C. To the cold solution was added 1.6 M ⁿBuLi in hexanes (0.67 mL, 1.07 mmol) dropwise. The dark red solution was stirred at r.t. for 4 h. To the solution was then added chlorodiisopropylphosphine (154.2 mg, 1.0 mmol) in 3 mL THF. The solution was stirred for 16 h at r.t., quenched by 1 mL methanol, and concentrated. The product was extracted from the resulting solid using CH₂Cl₂. Concentration of the extract gave PNmes-ⁱPr as a yellow oil. Yield: 204.0 mg, 61%.

¹H NMR (400.36 MHz, C₆D₆, 298 K): δ 1.00 (6H, dd, ³J_{HH}=7.0 Hz, ³J_{HP}=12.1 Hz PCH(CH₃)₂), 1.03 (6H, dd, ³J_{HH}=7.1 Hz, ³J_{HP}=9.7 Hz PCH(CH₃)₂), 2.14 (6H, s, 2CH₃), 2.19 (3H, s, CH₃), 3.02 (2H, d, ²J_{HP}=1.7 Hz, CH₂), 6.73 (H, pseudo d, aromatic CH), 6.86 (2H, s, aromatic 2CH), 7.14 (2H, m, overlapping with a residual C₆D₆ peak, aromatic 2CH).

¹³C{¹H}NMR (100.67 MHz, C₆D₆, 298 K): δ 19.1 (d, ²J_{CP}=10.6 Hz, PCH(CH₃)₂), 20.0 (d, ²J_{CP}=15.6 Hz, PCH(CH₃)₂), 20.6 (s, 2CH₃), 21.2 (s, CH₃) 24.0 (d, J_{CP}=15.7 Hz, 2PCH(CH₃)₂), 33.2 (d, J_{CP}=23.1 Hz, CH₂), 121.4 (d, ³J_{CP}=7.1 Hz, aromatic), 121.6 (s, aromatic), 128.6 (s, aromatic), 135.8 (s, aromatic, ipso), 136.1 (s, aromatic), 137.0 (s, aromatic, ipso), 139.2 (s, aromatic, ipso), 160.0 (s, aromatic, ipso), 161.3 (d, ²J_{CP}=9.3 Hz, aromatic).

³¹P{¹H}NMR (121.50 MHz, CDCl₃, 297 K): δ 13.7.

HRMS (ESI⁺) m/z calcd for C₂₁H₃₁NP⁺ ([M+H]⁺): 328.2194. Found: 328.2196.

### 2-(2,6-diisopropylphenyl)-6-(diisopropylphophinomethyl)pyridine-d₂(25, PNdipp-ⁱPr-d₂)

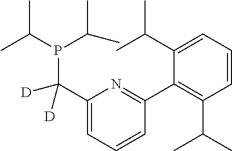 [SMILES: [2H]C([2H])(c1cccc(-c2c(C(C)C)cccc2C(C)C)n1)P(C(C)C)C(C)C]

In a nitrogen glove box, PNdipp-ⁱPr was prepared using 2-(2,6-diisopropylphenyl)-6-methylpyridine (synthesis described above; 128.3 mg, 0.5 mmol), 1.6 M ⁿBuLi in hexanes (0.32 mL, 0.51 mmol), and chlorodiisopropylphosphine (78.4 mg, 0.51 mmol). To a 20 mL vial containing PNdipp-ⁱPr was then added KO^{t}Bu (59 mg, 0.53 mmol). The content of vial was then quantitatively transferred into a J. Young NMR tube using THF (0.7 mL) and CD₃OD (0.5 mL). The solution was heated for 16 h at 80° C. and monitored by ¹H NMR. ¹H NMR spectra after 16 h of heating showed 91% deuteration of the benzylic CH₂. The concentrated solution was extracted using pentane, and concentrated to dryness. PNdipp-ⁱPr-d₂ was obtained as a off-white solid. Yield: 170.1 mg, 90%.

¹H NMR (400.36 MHz, CDCl₃, 298 K): δ 1.06 (18H, overlapping d, 2PCH(CH₃)₂ and CH(CH₃)₂), 1.12 (6H, d, ³J_{HH}=6.8 Hz, CH(CH₃)₂), 1.84 (2H, br 2PCH(CH₃)₂), 2.50 (2H, br, 2CH(CH₃)₂), 3.05 (0.19H, br, residual CH₂), 7.02 (1H, d, ³J_{HH}=6.8 Hz, aromatic CH), 7.19 (2H, d, ³J_{HH}=7.6 Hz, aromatic 2CH), 7.32 (1H, d, ³J_{HH}=8.0 Hz, aromatic CH), 7.37 (1H, d, ³J_{HH}=9.2 Hz, aromatic CH), 7.62 (1H, br t, ³J_{HH}=7.1 Hz aromatic CH).

¹³C{¹H}NMR (100.67 MHz, CDCl₃, 291 K): δ 19.0 (d, ²J_{CP}=9.2 Hz, PCH(CH₃)₂), 19.8 (d, ²J_{CP}=14.9 Hz, PCH(CH₃)₂), 23.6 (d, ¹J_{CP}=15.0 Hz, 2PCH(CH₃)₂), 23.8 (s, CH(CH₃)₂), 24.3 (s, CH(CH₃)₂), 30.2 (s, 2CH(CH₃)₂), 32.1 (detected by ¹H-¹³C HSQC, CH₂), 121.6 (d, ³J_{CP}=7.3 Hz, aromatic), 121.8 (s, aromatic), 122.6 (s, 2 aromatic CH), 128.3 (s, aromatic), 135.6 (s, aromatic), 139.0 (s, aromatic, ipso), 146.4 (s, 2 aromatic ipso C), 159.0 (s, aromatic, ipso), 160.3 (br, aromatic, ipso). ²H NMR (61.46 MHz, CDCl₃, 298 K) δ 3.08.

³¹P{¹H}NMR (121.50 MHz, CDCl₃, 291 K): δ 13.0 (PNdipp-ⁱPr-d₂, 86%), 13.2 (PNdipp-ⁱPr-d₁, 14%).

HRMS (ESI⁺) m/z calcd for C₂₄H₃₅D₂NP⁺ ([M+H]⁺): 372.2789. Found: 372.2791.

### 2-(2,4,6-triisopropylphenyl)-6-(diisopropylphophinomethyl)pyridine (26, PNtipp-ⁱPr)

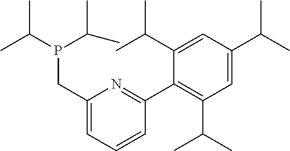 [SMILES: CC(C)c1cc(C(C)C)c(-c2cccc(CP(C(C)C)C(C)C)n2)c(C(C)C)c1]

In a nitrogen glove box, a 20 mL vial equipped with a Teflon coated stirring bar was charged with 2-(2,4,6-triisopropylphenyl)-6-methylpyridine (297.0 mg, 1.00 mmol) and 10 mL ether. The clear faint yellow solution was cooled to −35° C. To the cold solution was added 1.6 M ⁿBuLi in hexanes (0.65 mL, 1.04 mmol) dropwise. The orange suspension was stirred at r.t. for 1 h, and cooled to −35° C. To the solution was then added chlorodiisopropylphosphine (155.0 mg, 1.02 mmol) in 3 mL ether. The solution was stirred for 17 h at r.t., quenched by 0.5 mL methanol, and concentrated. The product was extracted from the resulting solid using n-pentane. Concentration of the pentane extract gave PNdipp-ⁱPr as an off-white solid. Yield: 394.5 mg, 95%.

¹H NMR (500.08 MHz, C₆D₆, 298 K): δ 1.02 (6H, overlapping dd, ³J_{HH}=7.1 Hz, ²J_{HP}=13.5 Hz, PCH(CH₃)₂), 1.05 (6H, overlapping dd, ³J_{HH}=7.0 Hz, ²J_{HP}=11.2 Hz, PCH(CH₃)₂), 1.22 (6H, d, ³J_{HH}=6.5 Hz, 2,6-CH(CH₃)₂), 1.29 (6H, d, ³J_{HH}=7.0 Hz, 2,6-CH(CH₃)₂), 1.31 (6H, d, ³J_{HH}=7.0 Hz, 4-CH(CH₃)₂), 1.70 (1H, d septet, ³J_{HH}=7.0 Hz, ²J_{HP}=1.6 Hz, 2PCH(CH₃)₂), 2.85 (2H, septet, ³J_{HH}=6.9 Hz, 2,6-CH(CH₃)₂), 2.90 (2H, septet, ³J_{HH}=7.0 Hz, 4-CH(CH₃)₂), 3.04 (2H, d, ²J_{HP}=1.8 Hz, CH₂), 6.91 (1H, dd, ³J_{HH}=6.8 Hz, ⁴J_{HH}=1.9 Hz, aromatic CH), 7.16 (2H, overlapping m, aromatic 2CH), 7.25 (2H, s, aromatic 2CH).

¹³C{¹H}NMR (125.75 MHz, C₆D₆, 298 K): δ 19.1 (d, ²J_{CP}=10.8 Hz, PCH(CH₃)₂), 19.9 (d, ²J_{CP}=15.5 Hz, PCH(CH₃)₂), 23.9 (d, J_{CP}=15.5 Hz, 2PCH(CH₃)₂), 24.3 (s, 2,6-CH(CH₃)₂), 24.4 (s, 2,6-CH(CH₃)₂), 24.6 (s, 4-CH(CH₃)₂), 30.8 (s, 2,6-CH(CH₃)₂), 33.2 (d, J_{CP}=23.5 Hz, CH₂), 34.9 (s, 4-CH(CH₃)₂), 120.8 (s, 2 aromatic CH), 121.5 (d, ³J_{CP}=7.5 Hz, aromatic), 122.0 (s, aromatic), 135.6 (s, aromatic), 137.7 (s, aromatic, ipso), 146.8 (s, 2 aromatic, ipso CH), 148.8 (s, aromatic, ipso), 160.0 (s, aromatic, ipso), 160.9 (d, ²J_{CP}=9.2 Hz, aromatic, ipso).

³¹P{¹H}NMR (121.50 MHz, CDCl₃, 291 K): δ 12.5.

HRMS (ESI⁺) m/z calcd for C₂₄H₃₇NP⁺ ([M+H]⁺): 412.3133. Found: 412.3129.

### Example 2

### Preparation of PN Iron Complexes of Structure A3

### FeCl₂(PNdipp-ⁱPr) (1)

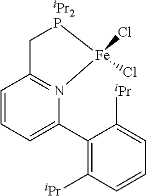

In a nitrogen glove box, a 20 mL vial equipped with a Teflon coated stirring bar was charged with FeCl₂ (13.4 mg, 0.106 mmol), PNdipp-ⁱPr (synthesis described in Example 1; 37.5 mg, 0.101 mmol) and 2 mL THF. The off-white suspension was stirred at r.t. for 6 h, filtered through Celite, and the Celite was washed with THF. The THF solution was concentrated, and n-pentane was added for crystallization. The off-white micro-crystalline solid was washed by pentane, and vacuum dried. Yield: 41.2 mg, 82%.

¹H NMR (300.13 MHz, C₆D₆, 291 K) δ −9.8 (2H), −8.4 (1H), −3.7 (6H), 2.7 (12H), 5.8, 5.9 (overlapping 3H), 8.7 (6H), 43.8 (1H), 46.4 (1H), 102.5 (2H) 130.7 (2H).

Elemental analysis: Calcd: H:7.31, C:58.08, N:2.82. Found: H:7.44, C:57.31, N:2.72.

μ_{eff} (Evans' method, CDCl₃, 292.6 K)=5.1 μ_{B}.

Diffusion coefficient (0.02 M in C₆D₆, 298 K): 0.877×10⁻⁹(0.008) m²/s.

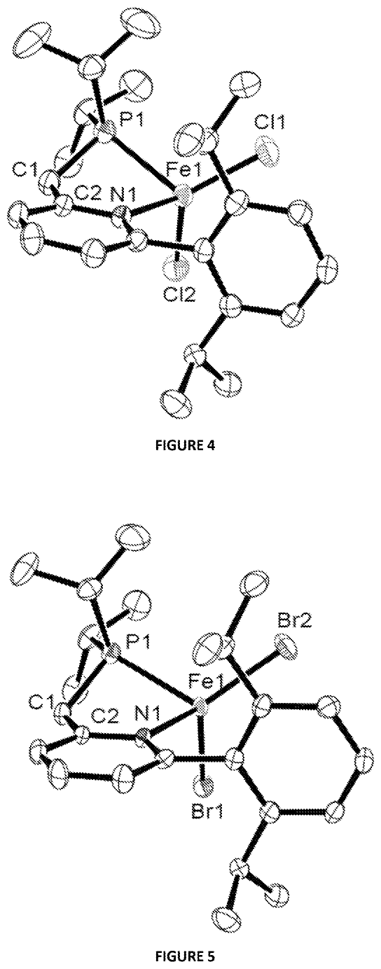

The X-ray structure of 1 is presented in FIG. 4 and its experimental details is presented in Table 1. The XRD analysis showed that 1 exhibits a tetrahedral geometry.

### FeCl₂(PNdipp-ⁱPr-d₂) (1-d₂)

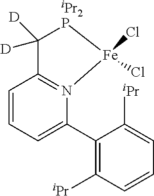

In a nitrogen glove box, a 20 mL vial equipped with a Teflon coated stirring bar was charged with FeCl₂ (62.3 mg, 0.49 mmol), PNdipp-ⁱPr-d₂ (37.5 mg, 0.46 mmol) and 6 mL THF. The off-white suspension was stirred at r.t. for 3 h, filtered through Celite, and the Celite was washed by THF. The THF solution was concentrated to ca.1 mL, and submitted to crystallization from THF/n-pentane. The off-white micro-crystalline solid was washed by pentane, and vacuum dried. Yield: 119.7 mg, 52%.

¹H NMR (300.13 MHz, C₆D₆, 294 K) δ −9.8 (2H), −8.2 (1H), −3.7 (6H), 2.7 (12H), 5.8, 5.9 (overlapping 3H), 8.9 (6H), 43.5 (1H), 46.2 (1H), 129.4 (2H).

²H NMR (61.46 MHz, C₆H₆, 298 K) δ 101.5.

Elemental analysis: Calcd: H:7.69, C:57.85, N:2.81. Found: H:7.33, C:57.75, N:2.76.

μ_{eff} (Evans' method, CDCl₃, 292.6 K)=5.4 μ_{B}. This is consistent with formation of high spin, S=2, Fe(II) complexes.

### FeBr₂(PNdipp-ⁱPr) (2)

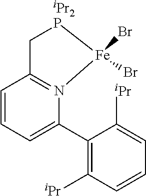

In a nitrogen glove box, a 20 mL vial equipped with a Teflon coated stirring bar was charged with FeBr₂ (106.6 mg, 0.494 mmol), PNdipp-ⁱPr (synthesis described in Example 1; 184.2 mg, 0.498 mmol) and 8 mL THF. The brown suspension was stirred at r.t. for 6 h, filtered through Celite, and the Celite was washed with THF. The THF solution was concentrated to dryness, and submitted to recrystallization from benzene/n-pentane. The off-white micro-crystalline solid was washed by pentane, and vacuum dried. Yield: 267.1 mg, 92%.

¹H NMR (300.13 MHz, CD₆, 291 K) δ −13.0 (2H), −8.5 (1H), −4.2 (6H), 1.5 (6H), 6.1, 6,9, 7.6 (overlapping 3 peaks, 15H), 45.7 (1H), 48.6 (1H), 119.0 (2H) 130.5 (2H).

Elemental analysis: Calcd: H:6.20, C:49.26, N:2.39. Found: H:6.22, C:49.77, N:1.99.

μ_{eff} (Evans' method, CDCl₃, 292.6 K)=5.2 μ_{B}. This is consistent with formation of high spin, S=2, Fe(II) complexes.

X-ray structure of 2 is presented in FIG. 5 and its experimental details is presented in Table 1. The XRD analysis showed that 2 exhibits a tetrahedral geometry.

TABLE 1
XRD experimental detail for 1 and 2.

| | 1 | 2 |
|---|---|---|
| Empirical formula | C24 H36 Cl2 Fe N P | C24 H36 Br2 Fe N P |
| Formula weight (g/mol) | 496.26 | 585.18 |
| Temperature (K) | 120(2) | 100(2) |
| Wavelength (Å) | 0.71073 | 0.71073 |
| Crystal system | Tetragonal | Tetragonal |
| Space group | P4₂/n | P4₂/n |
| a(Å) | 24.9310(5) | 25.090(3) |
| b (Å) | 24.9310(5) | 25.090(3) |
| c (Å) | 8.43400(10) | 8.5077(10) |
| α (°) | 90.0000(11) | 90 |
| β (°) | 90.0000(11) | 90 |
| γ (°) | 90.0000(9) | 90 |
| Volume (Å³) | 5242.2(2) | 5355.5(15) |
| Z | 8 | 8 |
| Density (calculated) (Mg/m³) | 1.258 | 1.452 |
| Absorption coefficient (mm⁻¹) | 0.851 | 3.618 |
| F(000) | 2096 | 2384 |
| Crystal size (mm³) | 0.50 × 0.05 × 0.05 | 0.943 × 0.164 × 0.124 |
| Theta range for data collection (°) | 1.634 to 27.498 | 2.296 to 26.344 |
| Reflections collected | 76928 | 40789 |
| Independent reflections | 6016 [R(int) = 0.1434] | 5461 [R(int) = 0.0671] |
| Completeness (to theta = °) | 99.9% (25.242) | 100% (25.242) |
| Absorption correction | Cylinder | Semi-empirical from equivalents |
| Max. and min. transmission | 0.811 and 0.804 | 0.7782 and 0.2388 |
| Refinement method | Full-matrix least-squares on F² | Full-matrix least-squares on F² |
| Data/restraints/parameters | 6016/0/270 | 5461/0/270 |
| Goodness-of-fit on F² | 0.916 | 1 |
| Final R indices [I > 2sigma(I)] | R1 = 0.0356, wR2 = 0.0775 | R1 = 0.0345, wR2 = 0.0622 |
| R indices (all data) | R1 = 0.0721, wR2 = 0.0855 | R1 = 0.0687, wR2 = 0.0722 |
| Extinction coefficient | n/a | n/a |
| Largest diff. peak and hole (e · Å⁻³) | 0.317 and −0.538 | 0.591 and −0.330 |

### FeCl₂(PNdipp-^{t}Bu) (3)

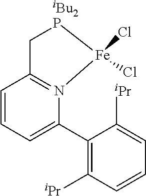

In a nitrogen glove box, a 20 mL vial equipped with a Teflon coated stirring bar was charged with FeCl₂ (25.1 mg, 0.198 mmol), PNdipp-Bu (synthesis described in Example 1; 82.0 mg, 0.206 mmol) and 2 mL THF. The off-white suspension was stirred at r.t. for 8 h, filtered through Celite, and the Celite was washed with THF. The THF solution was concentrated, washed by pentane, and vacuum dried to obtain off-white powder. Yield: 71.7 mg, 69%.

¹H NMR (300.13 MHz, C₆D₆, 291 K): δ −12.9 (1H), −9.1 (2H), −3.8 (6H), 3.38 (6H), 5.1, 5.2 (overlapping 3H), 10.0 (18H), 43.3 (1H), 45.1 (1H), 101.3 (2H).

Elemental analysis: Calcd: H:7.69, C:59.56, N:2.67. Found: H:7.91, C:59.69, N:2.34.

μ_{eff} (Evans' method, CDCl₃, 292.6 K)=4.7 μ_{B}. This is consistent with formation of high spin (4.6-5.1), S=2, Fe(II) complexes.

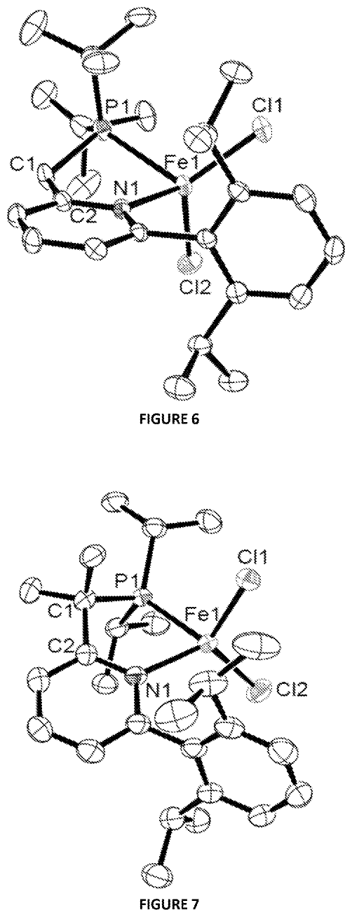

X-ray structure of 3 is presented in FIG. 6, and its experimental details is presented in Table 2. The XRD analysis showed that 3 exhibits a tetrahedral geometry.

### FeCl₂(PNdipp-ⁱPr-Me₂) (4)

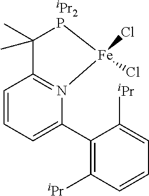

In a nitrogen glove box, a 20 mL vial equipped with a Teflon coated stirring bar was charged with FeCl₂ (26.0 mg, 0.205 mmol), PNdipp-ⁱPr-Me₂ (synthesis described in Example 1; 80.8 mg, 0.203 mmol) and 4 mL THF. The off-white suspension was stirred at r.t. for 17 h, filtered through Celite, and the Celite was washed with THF. The THF solution was concentrated, and submitted to crystallization from THF/n-pentane. The off-white solid was washed by pentane, and vacuum dried. Yield: 92.5 mg, 87%.

¹H NMR (300.13 MHz, CD₆, 291 K): δ −15.8 (overlapping 2H), −6.6 (2H), −5.3 (6H), 2.5 (6H), 6.8 (2H) 7.9 (2H), 25.3 (6H) 39.9 (1H), 54.7 (1H), missing 12H for PiPr₂ group.

Elemental analysis: Calcd: H:7.69, C:59.56, N:2.67. Found: H:7.79, C:60.46, N:2.52.

μ_{eff} (Evans' method, CDCl₃, 293.2 K)=4.7 μ_{B}.

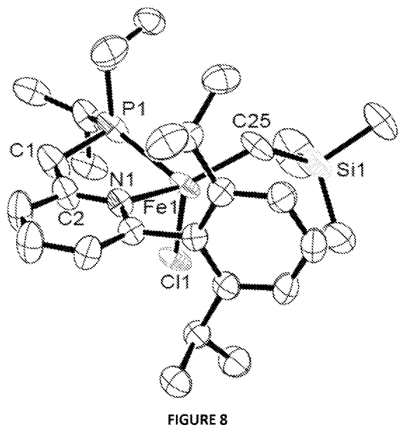

X-ray structure of 4 is presented in FIG. 7, and its experimental details is presented in Table 2.

TABLE 2
XRD experimental detail for (3) and (4).

| | FeCl₂(PNdipp-^{t}Bu) (3) | FeCl₂(PNdipp-ⁱPr-Me₂)(4) |
|---|---|---|
| Empirical formula | C56 H90 Cl4 Fe2 N2 O P2 | C26 H40 Cl2 Fe N P |
| Formula weight (g/mol) | 1122.73 | 524.31 |
| Temperature (K) | 100(2) | 100(2) |
| Wavelength (Å) | 0.71073 | 1.54184 |
| Crystal system | Orthorhombic | Triclinic |
| Space group | Fdd2 | P-1 |
| a(Å) | 27.288(2) | 8.65510(10) |
| b (Å) | 27.6504(16) | 11.64840(10) |
| c (Å) | 15.7169(8) | 17.0741(2) |
| α (°) | 90 | 71.5970(10) |
| β (°) | 90 | 78.7340(10) |
| γ (°) | 90 | 83.7520(10) |
| Volume (Å³) | 11858.6(13) | 1599.81(3) |
| Z | 8 | 2 |
| Density (calculated) (Mg/m³) | 1.258 | 1.088 |
| Absorption coefficient (mm⁻¹) | 0.761 | 5.863 |
| F(000) | 4784 | 556 |
| Crystal size (mm³) | 0.246 × 0.097 × 0.090 | 0.273 × 0.106 × 0.016 |
| Theta range for data collection (°) | 2.690 to 26.450 | 4.005 to 80.034 |
| Reflections collected | 20181 | 56574 |
| Independent reflections | 5873 [R(int) = 0.0506] | 6894 [R(int) = 0.0754] |
| Completeness (to theta = °) | 99.7% (25.242) | 99.7% (67.684) |
| Absorption correction | Semi-empirical from equivalents | Analytical |
| Max. and min. transmission | 0.9347 and 0.8351 | 0.980 and 0.827 |
| Refinement method | Full-matrix least-squares on F² | Full-matrix least-squares on F² |
| Data/restraints/parameters | 5873/2/326 | 6894/0/290 |
| Goodness-of-fit on F² | 1.157 | 1.11 |
| Final R indices [I > 2sigma(I)] | R1 = 0.0424, wR2 = 0.0684 | R1 = 0.0455, wR2 = 0.1257 |
| R indices (all data) | R1 = 0.0500, wR2 = 0.0731 | R1 = 0.0488, wR2 = 0.1282 |
| Extinction coefficient | n/a | n/a |
| Largest diff. peak and hole (e · Å⁻³) | 0.291 and −0.295 | 0.704 and −0.483 |

### FeCl₂(PNdipp-Et). (5)

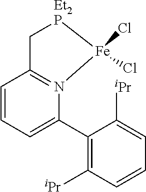

In a nitrogen glove box, a 20 mL vial equipped with a Teflon coated stirring bar was charged with FeCl₂ (25.3 mg, 0.2 mmol), PNdipp-Et (synthesis described in Example 1; 69.3 mg, 0.2 mmol) and 2 mL THF. The off-white suspension was stirred at r.t. for 5 h, filtered through Celite, and the Celite was washed with THF. The THF solution was concentrated to ca. 1 mL, and crystallized with pentane. The crystals were washed with pentane, and vacuum dried. Yield: 76.7 mg, 82%.

¹H NMR (300.13 MHz, C₆D₆, 291 K): δ −12.7 (2H), −5.1 (1H), −4.0 (6H), 1.6 (6H), 2.7 (6H), 6.1 (1H), 6.5 (2H) 44.5 (1H), 49.5 (1H), 112.3 (4H), 116.2 (2H).

Elemental analysis: Calcd: H:6.89, C:56.43, N:2.99. Found: H:6.79, C:55.11, N:2.76.

μ_{eff} (Evans' method, CDCl₃, 293.2 K)=5.1 μ_{B}.

### FeCl₂(PNdipp-Ph) (6)

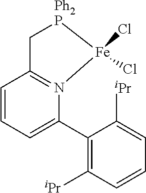

In a nitrogen glove box, a 20 mL vial equipped with a Teflon coated stirring bar was charged with FeCl₂ (35 mg, 0.276 mmol), PNdipp-Ph (synthesis described in Example 1; 83 mg, 0.190 mmol) and 6 mL THF. The brown suspension was stired at r.t. for 15 h, filtered through Celite, and the Celite was washed with THF. The THF solution was concentrated to ca. 1 mL. The product was precipitated by the addition of ether to the THF solution. The off-white precipitate was washed with ether, and vacuum dried. Yield: 76.5 mg, 71%.

¹H NMR (300.13 MHz, C₆D₆, 292 K): δ −12.7 (2H), −5.2 (2H), −5.0 (1H), −4.2 (6H), −1.8 (4H), 1.8 (6H), 5.6 (1H), 6.2 (2H), 16.9 (4H), 43.7 (1H), 51.1 (1H), 127.9 (2H).

Elemental analysis: Calcd: H:5.72, C:63.85, N:2.48. Found: H:5.70, C:63.72, N:2.32.

μ_{eff} (Evans' method, CDCl₃, 293.2 K)=4.8 μ_{B}.

### FeCl₂(PNmes-ⁱPr). (7)

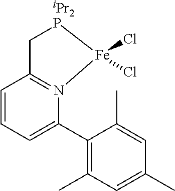

In a nitrogen glove box, a 20 mL vial equipped with a Teflon coated stirring bar was charged with FeCl₂ (26.6 mg, 0.21 mmol), PNmes-ⁱPr (Synthesis described in Example 1; 74.1 mg, 0.23 mmol) and 4 mL THF. The yellow suspension was stirred at r.t. for 17 h, concentrated, and extracted with CH₂Cl₂. Concentration of the solution gave faint yellow crystals. The crystals were washed by ether, and vacuum dried. Yield: 90.9 mg, 95%.

¹H NMR (300.13 MHz, C₆D₆, 291 K): δ −15.6 (1H), −4.2 (6H), 0.9 (3H), 1.3 (3H), 3.9 (3H), 6.2 (2H) 11.9 (6H), 43.4 (1H), 47.3 (1H), 100.0 (2H), 137.5 (2H).

Elemental analysis: Calcd: H:6.66, C:55.53, N:3.08. Found: H:6.59, C:53.48, N:2.77.

μ_{eff} (Evans' method, CDCl₃, 293.6 K)=5.3 μ_{B}.

### Complex 8

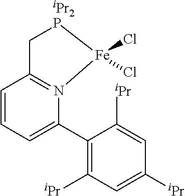

In a nitrogen glove box, a 20 mL vial equipped with a Teflon coated stirring bar was charged with FeCl₂ (63.8 mg, 0.503 mmol), PNtipp-ⁱPr (204.1 mg, 0.496 mmol) and 5 mL THF. The off-white suspension was stirred at r.t. for 16 h, filtered through Celite, and the Celite was washed with THF. The THF solution was concentrated, and n-pentane was added for crystallization. The off-white micro-crystalline solid was washed with pentane, and vacuum dried. Yield: 193.7 mg, 73%.

¹H NMR (300.13 MHz, C₆D₆, 293 K) δ −10.3 (2H), −8.1 (1H), −3.8 (6H), 2.7 (18H), 4.5 (1H), 6.0 (2H), 8.3 (6H), 43.6 (1H), 46.5 (1H), 102.7 (2H) 128.2 (2H).

Elemental analysis: Calcd: H:7.86, C:60.24, N:2.60. Found: H:7.69, C:57.53, N:2.49.

μ_{eff} (Evans' method, CDCl₃, 292.6 K)=4.6 μ_{B}.

### Example 3

### Preparation of PN Iron Complexes of Structures A1 and A2

### Complex 9

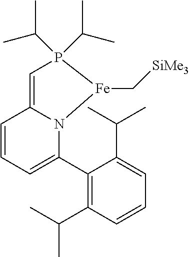

In a nitrogen glove box, to a NMR tube equipped with a septa were added complex 1 (7.4 mg, 0.015 mmol), trimethylsilylmethyllithium (2.9 mg, 0.031 mmol), and 0.5 mL C₆D₆. The solution was mixed by shaking the tube, and monitored by ¹H NMR at r.t. ¹H NMR spectra after 4 h showed full conversion of 1 and formation of 9 and SiMe₄.

¹H NMR (300.13 MHz, C₆D₆, 291 K) δ −134.1 (6H), −83.7 (6H), −50.5 (6H), −48.9 (1H), −45.2 (2H), −13.3 (6H), 68.4 (2H), 76.7 (1H), 84.1 (9H), 110.7 (1H), 178.1 (1H).

μ_{eff} (Evans' method, C₆H₆, 292.5 K)=5.3 μ_{B} (per Fe atom).

Diffusion coefficient (0.02 M in C₆D₆, 298 K): 0.633×10⁻⁹(0.019) m²/s.

Elemental analysis: Calcd: H:9.06, C:65.74, N:2.74. Found: H:9.10, C:65.25, N:2.41.

### Complex 10

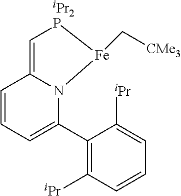

In a nitrogen glove box, a 4 mL vial was charged with 1 (5.2 mg, 0.011 mmol), neopentyllithium (1.8 mg, 0.023 mmol), and 0.5 mL C₆D₆. The solution was mixed by swirling the vial at r.t., and transferred into a J. Young NMR tube. ¹H NMR spectra after 30 min showed full conversion of 1 and formation of 10 and CMe₄.

¹H NMR (300.13 MHz, C₆D₆, 292 K, 20 mM) δ −132.5 (6H, 2,6-CH(CH₃)₂), −89.0 (6H, PCH(CH₃)₂), −50.5 (1H, para-CH of 2,6-Pr₂—C₆H₃), −49.6 (6H, PCH(CH₃)₂), −43.9 (2H, two ortho-CH of 2,6-ⁱPr₂—C₆H₃), −13.1 (6H, 2,6-CH(CH₃)₂), 70.0 (2H, P{CH(CH₃)₂}), 75.6 (1H, CH from pyridine ring), 106.7 (1H, CH from pyridine ring), 158.2 (9H, CMe₃), 182.1 (1H, CH from pyridine ring), 300.0 (1H, CHPⁱPr₂). ¹H NMR signals from 2,6-CH(CH₃)₂ and CH₂CMe₃ were not detectable due to proximity to the iron center.

Elemental analysis: Calcd: H:9.36, C:70.29, N:2.83. Found: H:9.32, C:69.25, N:2.58.

μ_{eff} (Evans' method, C₆D₆, 292.0 K)=5.8 μ_{B}.

Diffusion coefficient (20 mM in C₆D₆, 298 K): 0.804×10⁻⁹(0.018) m²/s.

### NMR Diffusion Measurements:

NMR diffusion measurements were performed using an Avance III HD Bruker 500 MHz spectrometer equipped with a gradient system capable of producing magnetic field pulse gradients in the z-direction of about 50 G cm⁻¹. The diffusion experiments were performed using the LED (longitudinal eddy current delay) diffusion sequence. Sine shape pulsed-gradients of 6 ms duration were incremented from 0.7 to 32.2 G cm⁻¹ in 10 linear steps and the pulse gradient separation was 7 ms. All experiments were performed three times using residual C₆D₆ signal as a secondary reference, and the reported values are means with standard deviation in a bracket. All measurements were performed at 298 K using 0.02 M solutions, and analyzed using TopSpin 3.5.

### Stock Solution of Complex 9, or 10.

In a nitrogen glove box, a 20 mL vial equipped with a Teflon coated stirring bar was charged with 1 (25 mg, 0.05 mmol), and trimethylsilylmethyllithium or neopentyllithiu^{m(}0.10 mmol). 5.00 mL C₆H₆ was then added to the vial to form a clear red solution. The solution was stirred at r.t. for 5 h or 30 min for 9 or 10, respectively, to form dark red solution. The solution was then filtered through Celite to remove LiCl. An aliquot of this solution was analyzed by ¹H NMR to confirm the cleₐn formation of 9 or 10. The resulting dark red solution was used as an 0.0050 M stock solution of 9 or 10.

### Complex 11

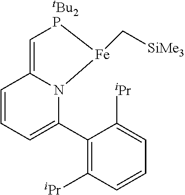

In a nitrogen glove box, to a 20 mL vial equipped with a Teflon coated stirring bar were added complex 3 (26.2 mg, 0.050 mmol), trimethylsilylmethyllithium (10.2 mg, 0.108 mmol), and 3 mL C₆H₆. The solution was stirred for 4 h at r.t. The solution was concentrated to dryness. The resulting black oil was extracted using pentane, and the pentane solution was concentrated to ca. 0.1 mL. Black crystals of 11 were obtained from the solution upon storing the solution at −25° C. for overnight. The supernatant solution was removed, and the crystal was dried under high vacuum. Yield: 23.4 mg, 87%.

¹H NMR (500.08 MHz, C₆D₆, 298 K, 40 mM) δ −127.2 (6H, 2,6-CH(CH₃)₂), −79.7 (6H, PCH(CH₃)₂), −47.5 (6H, PCH(CH₃)₂), −46.3 (1H, para-H of 2,6-ⁱPr₂—C₆H₃), −42.4 (2H, ortho-H of 2,6-ⁱPr₂—C₆H₃), −12.6 (6H, 2,6-CH(CH₃)₂), 69.0 (2H, P{CH(CH₃)₂}), 73.2 (1H, CH from pyridine ring), 80.6 (9H, SiMe₃), 106.6 (1H, CH from pyridine ring), 171.7 (1H, CH from pyridine ring), 286.3 (1H, CHPⁱPr₂). ¹H NMR signals from 2,6-CH(CH₃)₂ and CH₂SiMe₃ were not detectable due to proximity to the iron center.

Elemental analysis: Calcd: H:9.34, C:66.77, N:2.60. Found: H:9.42, C:66.77, N:2.48.

μ_{eff} (Evans' method, C₆D₆, 292.5 K)=6.1 μ_{B}

Effective g value (9.381 GHz, C₆H₆, 5 K)=8.0.

Diffusion coefficient (17 mM in C₆D₆, 298 K): 0.835×10⁻⁹(0.007) m²/s.

Solid state structure of 11 was obtained using XRD. The XRD analysis of 11 showed a 3-coordinate, trigonal planar iron-alkyl complex with a dearomatized pyridine ligand, and a short iron-carbon bond (2.0176 Å).

Broad X-band EPR signals with effective g-value of 8.0 for 11 is consistent with S=2, Fe(II) complexes. The solution magnetic moment of is consistent with high-spin, S=2, trigonal planar Fe(II) complexes with a large spin-orbit coupling due to the small bite angle of the PN ligands. Despite the dimeric solid state structure of 12, the similarity of the ¹H NMR spectra of 9, 10, and 12 supports formation of monomeric, trigonal planer Fe(II)-alkyl complex in solution. The observation of CHPR¹₂ signals supports formation of monomeric species, since a CH peak adjacent to paramagnetic iron is known to be ¹H NMR silent. ¹H NMR signals along the Fe—C axis are shifted downfield, and signals perpendicular to the Fe—C axis are shifted upfield due to the large spin-orbit coupling. The concentration dependent change of the ¹H NMR chemical shift of 9, 10, and 12 suggests the presence of dimer-monomer equilibrium in solution.

### Complex 12

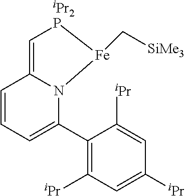

In a nitrogen glove box, to a 20 mL vial equipped with a Teflon coated stirring bar were added complex 8 (53.8 mg, 0.100 mmol), trimethylsilylmethyllithium (19.9 mg, 0.211 mmol), and 4 mL C₆H₆. The solution was stirred for 5 h at r.t. The solution was concentrated to dryness. The resulting oil was extracted using pentane, and the pentane solution was concentrated to ca. 0.1 mL. Black crystals of 12 were obtained from the solution upon storing the solution at −25° C. for overnight. The supernatant solution was removed, and the crystal was dried under high vacuum. Yield: 29.5 mg, 53%. ¹H NMR signals from 2,6-CH(CH₃)₂ and CH₂SiMe₃ were not detectable due to proximity to the iron center.

¹H NMR (300.13 MHz, C₆D₆, 293.7 K, 18 mM) δ −135.8 (6H, 2,6-CH(CH₃)₂), −85.7 (6H, PCH(CH₃)₂), −50.0 (6H, PCH(CH₃)₂), −46.1 (2H, ortho-H of 2,4,6-ⁱPr₂—C₆H₃), −14.2 (6H, 2,6-CH(CH₃)₂), −10.3 (1H, 4-CH(CH₃)₂), −8.7 (6H, 4-CH(CH₃)₂), 67.8 (2H, P{CH(CH₃)₂}), 76.3 (1H, CH from pyridine ring), 85.4 (9H, SiMe₃), 112.4 (1H, CH from pyridine ring), 178.6 (1H, CH from pyridine ring), 294.8 (1H, CHPⁱPr₂).

Elemental analysis: Calcd: H:9.47, C:67.25, N:2.53. Found: H:9.97, C:69.48, N:2.36.

μ_{eff} (Evans' method, C₆D₆, 293.7 K)=5.6 μ_{B}.

μ_{eff} (SQUID, 300.0 K)=5.2 μ_{B}.

Diffusion coefficient (17 mM in C₆D₆, 298 K): 0.772×10⁻⁹ (0.016) m²/s.

Complex 12 crystalized as a dimer (13). The XRD structure of 13 (the dimer of 12) exhibited dimerization of 3-coordinate iron centers via the deprotonated PN ligands to form 4-coordinate tetrahedral iron centers. The increased Fe—C—Si angle of 124.56° in 13 indicates the presence of steric congestion around the iron center which may promote α-hydrogen elimination or abstruction.

### Complex 14

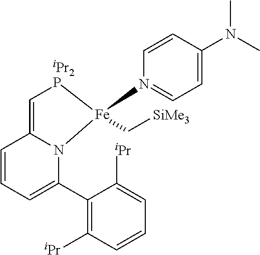

In a nitrogen glove box, a 20 mL vial equipped with a Teflon coated stirring bar was charged with 1 (49.4 mg, 0.10 mmol), trimethylsilylmethyllithium (1.98 mg, 0.21 mmol), and 3.00 mL C₆H₆. The solution was stirred for 7 h at r.t. To the dark red solution was added 4-dimethylaminopyridine (12.5 mg, 0.10 mmol) as a solid. The solution was stirred for 10 min to form a dark brown solution, and concentrated to dryness. The brown solid was extracted with pentane. Dark brown crystalline plates of 14 were obtained from a concentrated (ca. 1 ml) pentane solution at −35° C. The crystals were washed three times with cold pentane, and vacuum dried. Yield: 55.4 mg, 88%.

¹H NMR (300.13 MHz, toluene-d₈, 293 K) δ −36.0 (1H), −23.6 (3H), −12.7 (3H), −9.2 (3H), −6.3 (3H), −4.6 (3H), −1.1 (3H), −0.9 (3H), 4.1 (6H), 5.6 (3H), 9.2 (overlapping 4H), 19.3 (9H), 33.0 (2H), 39.3 (1H), 61.1 (1H), 69.0 (1H), 139.2 (br, 2H), 171.2 (1H), 179.8 (1H), a peak with 1H integration was not detected.

Elemental analysis: Calcd: H:6.63, C:66.33, N:8.91. Found: H:6.48, C:66.39, N:8.42.

μ_{eff} (Evans' method, C₆H₆, 293.5 K)=4.9 μ_{B}.

X-ray structure of 14 is presented in FIG. 1C, and its experimental details is presented in Table 3. XRD analysis of 14 showed a tetrahedral geometry with a dearomatized pyridine ligand. The solution magnetic moment of 4.9 s and a broad X-band EPR signals with effective g-value of 6.9 support the formation of a S=2, Fe(II) complex. Addition of 1.4 equiv of BPh₃ to the DMAP complex 14 in C₆D₆ quantitatively regenerated 9 along with the formation of DMAP-BPh₃ adduct (FIG. 1B).

TABLE 3
XRD experimental detail for 9 and 14.

| | 9 | 14 |
|---|---|---|
| Empirical formula | C62 H112 Cl2 Fe2 N2 O P2 Si4 | C40 H68 Fe N3 P Si |
| Formula weight (g/mol) | 1258.43 | 705.88 |
| Temperature (K) | 100(2) | 100(2) |
| Wavelength (Å) | 0.71073 | 0.71073 |
| Crystal system | Monoclinic | Monoclinic |
| Space group | P2₁/c | P2₁/c |
| a(Å) | a = 14.622(3) | 19.3088(14) |
| b (Å) | b = 16.267(3) | 13.7666(7) |
| c (Å) | c = 15.612(4) | 31.174(2) |
| α (°) | a = 90 | 90 |
| β (°) | b = 101.476(11) | 90.076(7) |
| γ (°) | g = 90 | 90 |
| Volume (Å³) | 3639.1(14) | 8286.6(9) |
| Z | 2 | 8 |
| Density (calculated) (Mg/m³) | 1.148 | 1.132 |
| Absorption coefficient (mm⁻¹) | 0.618 | 0.461 |
| F(000) | 1356 | 3072 |
| Crystal size (mm³) | 0.200 × 0.150 × 0.150 | 0.124 × 0.095 × 0.042 |
| Theta range for data collection (°) | 2.663 to 25.348 | 3.494 to 27.483 |
| Reflections collected | 48148 | 81114 |
| Independent reflections | 6667 [R(int) = 0.0474] | 18937 [R(int) = 0.0792] |
| Completeness (to theta = °) | 99.8% (25.242) | 99.7% (25.242) |
| Absorption correction | Semi-empirical from equivalents | Analytical |
| Max. and min. transmission | 0.9088 and 0.8809 | 0.993 and 0.981 |
| Refinement method | Full-matrix least-squares on F² | Full-matrix least-squares on F² |
| Data/restraints/parameters | 6667/0/390 | 18937/0/853 |
| Goodness-of-fit on F² | 1.145 | 1.078 |
| Final R indices [I > 2sigma(I)] | R1 = 0.0612, wR2 = 0.1346 | R1 = 0.0782, wR2 = 0.1559 |
| R indices (all data) | R1 = 0.0759, wR2 = 0.1432 | R1 = 0.1234, wR2 = 0.1718 |
| Extinction coefficient | n/a | n/a |
| Largest diff. peak and hole (e · Å⁻³) | 0.564 and −0.593 | 0.981 and −0.616 |

Formation of 9 from 14 by the Addition of BPh₃:

A J. Young NMR tube was charged with 12(3.2 mg, 0.0050 mmol), and 0.5 mL CD₆. To the brown solution was then added BPh₃ (1.7 mg, 0.0070 mmol). The solution was mixed by shaking the tube at r.t. Upon mixing, the solution color turned dark red. ¹H NMR spectra taken after 5 min showed complete conversion of 14 to 9 along with formation of BPh₃-DMAP adduct [H. Tobita, K. Ishiyama, Y. Kawano, S. Inomata, H. Ogino, Organometallics 17, 789 (1998)](confirmed by ¹¹B NMR).

### Example 4

Polymerization of Olefins Using the Catalysts of this Invention

### General Procedure for Polymerization of Olefins

In a nitrogen glove box, a 20 mL vial equipped with a Teflon coated stirring bar was charged with stock solution of a catalyst (1.0 ml, 0.005 mmol), and the appropriate olefin (1 mmol). The solution was stirred for hours indicated in Table 4 below at 25° C. The reaction was quenched by addition of 1 mL THF. The polymer was washed three times with 4 mL each of pentane, and died under vacuum (<0.1 mbar) to form a white solid of polymers. In case of polymerization of exo/endo-5-trimethylsilyl-2-norbornene and 3-phenyl-cyclopropene, MeOH was used in place of THF and pentane as the product is soluble in these solvents.

TABLE 4
ROMP of cyclic olefins catalyzed by iron complex of the invention

| Entry | Catalyst | Olefin | Polymer | Time (hours) | Isolated yield (%) |
|---|---|---|---|---|---|
| 1 | 9 | 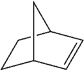 | 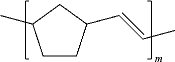 | 12 | 100 |
| 2 | 10 | 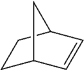 | 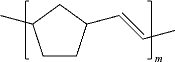 | 12 | 98 |
| 3 | 12 | 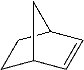 | 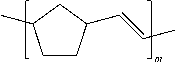 | 14 | 98 |
| 4 | 11 | 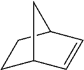 | 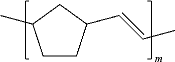 | 30 | 2 |
| 5 | 14 | 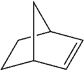 | n.a. | 23 | 0 |
| 6^{§} | 14 | 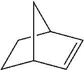 | 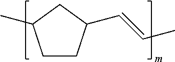 | 16 | 84 |
| 7 | 9 | 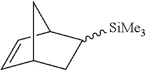 [SMILES: C[Si](C)(C)C1CC2C=CC1C2] | 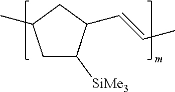 | 16 | 53 |
| 8 | 9 | 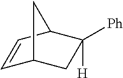 [SMILES: C1=CC2CC1CC2c1ccccc1] | 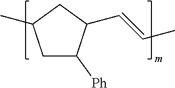 | 16 | 99 |
| 9 | 9 | 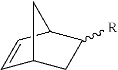 | n.a. | 16 | 0 |
| | | R = COOEt, OH, | | | |
| | | Si(OEt)₃, CONH₂ | | | |
| 10 | 9 | 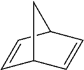 | n.a. | 65 | 0 |
| 11 | 9 | 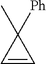 | 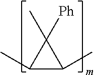 | 20 | 80 |
| 12^{†} | 9 | 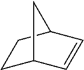 | 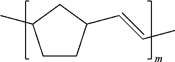 | 16 | 100 |

*Catalyst (0.010 mmol) and olefin (1 mmol) were stirred in benzene (1 mL) under N₂ at 25° C. Ph: phenyl, Et: ethyl.
^{§}BPh₃ (0.009 mmol) was added.
^{†}9 (0.01 mmol), water (0.0036 mmol), norbornene (5 mmol), and benzene (5 ml) were used.

### Poly(exo/endo-5-trimethylsilyl-2-norbornene) (I—SiMe₃)

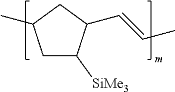

Off-white solid.

¹H NMR (300.13 MHz, CDCl₃, 293 K) δ 0.05 and −0.03 (9H, s, SiMe₃), 0.86-2.00 (5H, br, 2CH₂ and CHSiMe₃), 2.36 and 2.75 (2H, br, 2CH), 5.28 (2H, br, olefinic 2CH).

### Poly(exo-5-phenyl-2-norbornene) (I-Ph)

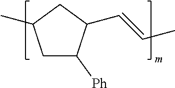

Off-white solid.

¹H NMR (300.13 MHz, CDCl₃, 293 K) δ 1.3-3.5 (7H, broad peaks, 3CH and 2CH₂), 5.26 (2H, br m, olefinic 2CH), 6.9-7.5 (5H, broad peaks, aromatic 5CH).

### Poly(3-phenyl-cyclopropene) (poly-CP)

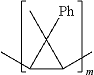

Off-white solid. ¹H NMR (300.13 MHz, CDCl₃, 293 K) δ 1.4 (5H, br, CH₃ and 2CH), 6.99 (5H, br, aromatic 5CH).

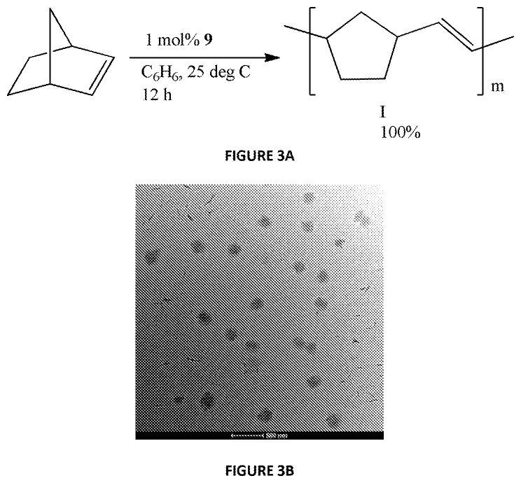

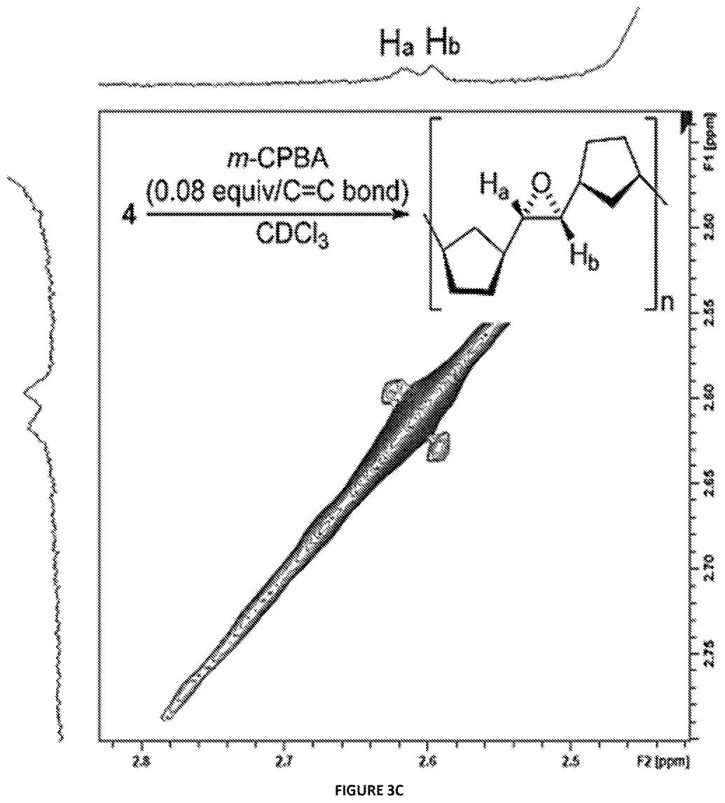

When 100 equiv. of norbornene were added to a benzene solution of 9 at 25° C., an insoluble polymer formed quickly around the magnetic stirring bar. After 12 h at 25° C., the polymer was isolated in 100% yield (FIG. 3A, Table 4, entry 1). Characterization of the polymer was done in CDCl₃ at 100° C. under 5 bar of N₂. Based on comparison of ¹H and ¹³C{¹H}NMR of completely dissolved polymer with polynorbornene prepared using the Grubbs I catalyst, the polymer was determined to be a highly stereoregular ROMP polymer, I, that contains trans-C═C bonds exclusively. The infrared (IR) spectrum of the bulk solid polymer also supports that I is pure trans-polynorbornene. The exclusive trans-selective olefin metathesis from cis-olefins is unprecedented, despite recent progress in stereoretentive trans-selective cross metathesis reactions. Further, ¹H-¹H gCOSY NMR spectra of partially epoxidized I enabled to determine I as an isotactic polymer (FIG. 3C). Thus, I is an unprecedented trans-isotactic polynorbornene. The cis-syndiotactic form of I was obtained using Mo, W, or Ru catalysts, and using Mo or W catalysts the cis-isotactic form of I was obtained. The solubility of the polymer improves upon storing the polymer for ca. 2 weeks in air under ambient conditions, or under oxygen, due to partial oxidation of the C═C bonds. Molecular weight determination of I by gel permeation chromatography (GPC) was not possible due to the low solubility of I in common GPC solvents. The molecular weight of I was estimated using dynamic light scattering (DLS) measurement of a chloroform solution of I and polystyrene standards. DLS measurement of I (prepared as shown in FIG. 3A) in two different dilutions, 0.058 and 0.012 mg/mL, showed monodisperse size distributions with mean hydrodynamic radii of 205.3 and 202.7 nm respectively. In comparison, DLS measurement of polystyrene standard with weight average molecular weight (M_{w}) of 0.925×10⁶, 6.28×10⁶ and 12.9×10⁶ Da revealed smaller mean hydrodynamic radii of 38.1, 47.9 and 53.6 nm respectively in chloroform. Furthermore, TEM image of dried 0.058 mg/mL chloroform solution of I showed spherical molecule of I with a mean radius of 123.8 nm for the TEM detectable core part of the sphere (FIG. 3B). Thus, based on size analysis, the molecular weight of I is most likely larger than 12.9×10⁶ Da. Low polydispersity indexes of 0.089 and 0.025 were obtained based on DLS and TEM measurements, respectively.

### Polymerization of Norbornene Catalyzed by 9.

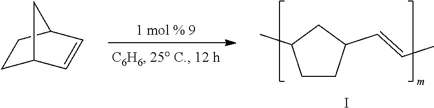

In a nitrogen glove box, a 20 mL vial equipped with a Teflon coated stirring bar was charged with a stock solution of 9 (1.0 ml, 0.010 mmol). To the dark red solution was added solid norbornene (97.6 mg, 1.04 mmol). Polymeric material started to form around the stirring bar as soon as norbornene was added. After 12 h of stirring at 25° C., all solution solidified due to absorption of C₆H₆ by the product polymer. The reaction was quenched by addition of 1 mL THF. The polymer was washed three times with 4 mL each of pentane, and dried under vacuum (<0.1 mbar) to form a white solid of I. Yield: 98.2 mg, quantitative. The polymer was dissolved in trichloroethylene at 90° C., and analyzed by ¹H NMR and IR (thin film). The bulk polymer was grinded with KBr in the glove box and analyzed by IR (KBr pellet). ¹³C{¹H}NMR was measured using the polymer stored in air to increase solubility in CDCl₃.

¹H NMR (400.36 MHz, trichloroethylene (6.43 ppm with respect to TMS), 298 K): δ 1.11 (1H, pseudo q, J_{HH}=10.2, 12.5 Hz, CH₂), 1.40 (2H, m, CH₂), 1.79 (2H, m, CH₂), 1.91 (1H, m, CH₂), 2.46 (2H, br, 2CH), 5.39 (2H, dd, J_{HH}=1.7, 3.8 Hz, 2CH).

¹³C{¹H}NMR (100.67 MHz, CDCl₃, 291 K): δ 32.2 (CH₂), 41.4 (CH₂), 43.1 (CH), 133.0 (═CH).

IR (KBr, thin film, cm⁻¹): 666 (s, CH₂ rocking), 694 (s, olefinic trans-CH out-of-plane vibration).

IR (KBr pellet, cm⁻¹): 694 (s, olefinic trans-CH out-of-plane vibration).

### Polymerization of Norbornene Catalyzed by 10.

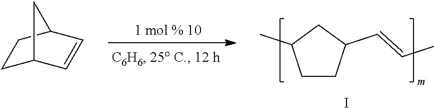

Using the same procedure described above, 91.7 mg (98% yield) of I was obtained the using stock solution of 10 (1.0 ml, 0.010 mmol) and norbornene (93.2 mg, 0.99 mmol).

### Polymerization of Norbornene Using 14.

In a nitrogen glove box, a 20 mL vial equipped with a Teflon coated stirring bar was charged with 14 (6.2 mg, 0.0098 mmol), and 1.0 mL C₆H₆. To the solution was added solid norbornene (95.9 mg, 1.02 mmol). No formation of polymer was observed upon stirring the solution for 23 h at 25° C.

### Polymerization of Norbornene Using 14 and BPh₃.

In a nitrogen glove box, a 20 mL vial equipped with a Teflon coated stirring bar was charged with 14 (6.0 mg, 0.0095 mmol), BPh₃ (2.1 mg, 0.0087 mmol), and 1.0 mL n-pentane. The brown suspension was stirred for 5 h at r.t., filtered using Celite, and the Celite was washed with 1.0 mL n-pentane. A white powder of BPh₃-DMAP complex [H. Tobita, K. Ishiyama, Y. Kawano, S. Inomata, H. Ogino, Organometallics 17, 789 (1998)](confirmed by ¹H and ¹¹B NMR) was collected on the Celite. The pentane solution was concentrated to dryness, and dissolved in 1.0 mL C₆H₆. To the solution was added solid norbornene (96.6 mg, 1.03 mmol). After 16 h of stirring at 25° C., all solution solidified due to absorption of C₆H₆ by the product polymer. The reaction was quenched by addition of 1 mL THF. The polymer was washed three times with 4 mL each of pentane, and dried under vacuum (<0.1 mbar) to form a white solid of I. Yield: 80.9 mg, 84%.

### Oxidation of Polynorbornene (I).

Upon standing in air for ca. two weeks, the polymer became soluble in CDCl₃. In a control experiment, I was kept under 2 bar of O₂ for 9 days and became soluble in CDCl₃. IR spectra of the oxidized polymer showed new C═O stretches around 1700 cm⁻¹, however ¹H NMR and ¹³C{¹H}NMR did not detect structural changes resulting from exposure to air or O₂.

¹H NMR (400.36 MHz, CDCl₃, 298 K): δ 1.05 (1H, pseudo q, J_{HH}=10.7, 12.1 Hz, CH₂), 1.34 (2H, m, CH₂), 1.76 (2H, m, CH₂), 1.86 (1H, dt, J_{HH}=6.6, 12.3 Hz, CH₂), 2.42 (2H, br, 2CH), 5.34 (2H, m, 2CH).

¹³C{¹H}NMR (100.67 MHz, CDCl₃, 291 K): δ 32.2 (CH₂), 41.4 (CH₂), 43.1 (2CH), 133.0 (2CH).

IR (KBr, thin film, cm⁻¹): 666 (w, CH₂ rocking), 694 (s, olefinic trans-CH out-of-plane vibration), 1717 (s, C═O stretching).

### Determination of Tacticity of I. (Prepared Using Complex 9)

In a nitrogen glove box, to a NMR tube equipped with a septa were added I (1.5 mg, contains ˜0.016 mmol C═C bonds, stored under air to increase solubility), and 0.50 mL CDCl₃. The purity of I was confirmed by ¹H NMR before addition of meta-chloroperbenzoic acid (m-CPBA). To the solution was then added a stock solution of m-CPBA in CDCl₃ (prepared using 1.5 mg of 77% m-CPBA (Aldrich)) and 0.50 mL CDCl₃, 0.013 M, 0.1 mL, 0.0013 mmol). ¹H NMR spectra after 1 h showed epoxidation of 5% of the C═C bonds in I and formation of meta-chlorobenzoic acid. ¹H NMR spectra showed α-hydrogens of the resulting epoxide at 2.60 ppm as a pseudo triplet. Upon decoupling of β-hydrogens at 1.87 ppm, the pseudo triplet signal was resolved to two broad singlet signals at 2.61 and 2.59 ppm. ¹H-¹H-gCOSY spectra showed coupling between these two signals. Based on this observation, the tacticity of I was determined to be isotactic.

### Epoxydation of I to Form Trans-Polyepoxide II.

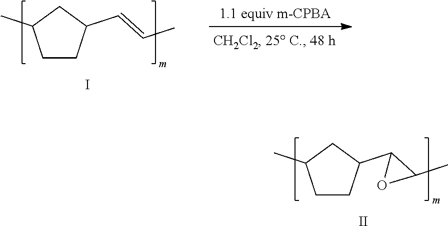

In a nitrogen glove box, a 20 mL vial equipped with a Teflon coated stirring bar was charged with a chunk of I (46.2 mg, 0.5 mmol), m-CPBA (77%, 136.6 mg, 0.6 mmol), and 4 mL dichloromethane. The suspension of I was stirred for 48 h at r.t. to form a white precipitate and a colorless solution. The solution was concentrated to form a white solid. The solid was washed five times with 10 mL each of ether to remove meta-chlorobenzoic acid and excess m-CPBA. The resulting colourless oil was dried to form a colorless film. Yield: 62.7 mg, quantitative. Based on comparison of ¹H, and ¹³C{¹H}NMR spectra with cis/trans mixture of II (see next experiment), the polymer was assigned as an atactic trans-polyepoxide II.

¹H NMR (400.36 MHz, CDCl₃, 298 K): δ 1.20 (1H, pseudo q, CH₂), 1.49 (2H, br, CH₂), 1.75 (2H, br, CH₂), 1.86 (3H, br, 2CH₂), 2.62 (2H, br, 2CH).

¹³C{¹H}NMR (100.67 MHz, CDCl₃, 298 K): δ 28.0 and 28.2 (CH₂), 32.1 and 32.2 (CH₂), 41.16 to 41.54 (4 peaks, 2CH), 60.65 to 61.15 (4 peaks, 2CH).

IR (KBr, thin film, cm⁻¹): 730 (s, symmetric epoxide ring deformation), 892 (s, asymmetric epoxide ring deformation).

Analysis of the Reaction Solution after Polymerization.

In a nitrogen glove box, a 20 mL vial equipped with a Teflon coated stirring bar was charged with a stock solution of 9 (1.0 ml, 0.010 mmol, containing 0.01 mmol of mesitylene as an internal standard). To the dark red solution was added a solid norbornene (96.0 mg, 1.02 mmol). After 16 h of stirring at 25° C., most of the solution solidified due to absorption of C₆H₆ by the product polymer. A part of the reaction solution was extracted by C₆H₆ and analyzed by ¹H and ³¹P{1H}NMR. ¹H NMR spectra showed virtually no consumption of the complex 10 based on integration value with respect to internal standard. The polymer was washed three times with 4 mL each of pentane, and dried under vacuum (<0.1 mbar) to form a white solid of I. Yield: 95.5 mg, 99%.

Reuse of the Reaction Solution after Polymerization of Norbornene.

In a nitrogen glove box, a 20 mL vial equipped with a Teflon coated stirring bar was charged with a stock solution of 9 (1.0 ml, 0.010 mmol). To the dark red solution was added solid norbornene (99.7 mg, 1.06 mmol). After 19 h of stirring at 25° C., most of the solution solidified due to absorption of C₆H₆ by the product polymer. The polymer was washed three times with 2 mL each of pentane, and dried under vacuum (<0.1 mbar) to form a white solid of I (96.2 mg, 96%). To the collected reaction solution in a mixture of pentane (6 mL) and C₆H₆(1 mL) was added solid norbornene (97.0 mg, 1.03 mmol). After 16 h of stirring at 25° C., white chunky precipitate of I was formed. The polymer was washed three times with 2 mL each of pentane, and dried under vacuum (<0.1 mbar) to form a white solid of I (108 mg, quantitative).

### Example 5

Catalytic Activity of the Complexes of this Invention

The catalytic activity of compounds of formula A2 was examined. 10 and 12 showed similar catalytic activity as 9. By contrast, complex 11 formed only 2% yield of the polymer after 30 h (Table 4, entries 2-4), likely due to steric crowding around the iron center. Complex 14 was inactive towards ROMP (Table 4, entry 5). However, significantly, 14 became catalytically active upon abstraction of the DMAP ligand by the addition of 1 equiv BPh₃, generating 9 and the DMAP-BPh₃ adduct (Table 4, entry 6). The catalytic inactivity of 14 supports the requirement of 3-coordinate iron complexes for ROMP activity.

ROMP of other cyclic alkenes was examined using 1 mol % of 9. The SiMe₃₋ and phenyl-functionalized norbornene were polymerized in moderate to high yields (Table 2, entry 7 and 8). The presence of oxygen or nitrogen functionality is detrimental for the catalysis (Table 4, entry 9), likely due to the coordination of these functionalities to 9 to form complexes similar to the DMAP complex 14. Peculiarly, norbornadiene did not undergo polymerization despite its structural similarity to norbornene (Table 4, entry 10). Cyclooctene and cyclopentene did not undergo polymerization, whereas the more strained cyclopropene polymerized via an addition-polymerization mechanism to generate a saturated polymer (Table 4, entry 11).

Along the course of the study, we found that addition of less than 1 equiv./iron of water to a solution of complex 9 generates a more active catalyst, whereas addition of more than 1 equiv. of water deactivates the catalyst. Thus, when 0.5 equiv. of water was added to a solution of complex 9 and 200 equiv of norbornene, turnover number (TON) of 62 was observed in 10 min, while TON of <4 was observed in 10 min without addition of water or with addition of 1.25 equiv of water. In the presence of 0.75 equiv of water, 0.1 mol % of 9 polymerized norbornene in 100% yield in 16 hours (Table 4, entry 12).

### Example 6

Effect of Water on the Catalytic Activity of the Catalysts of this Invention

In a nitrogen glove box, a 20 mL vial equipped with a Teflon coated stirring bar was charged with a sample of the stock solution of 9 (0.50 ml, 0.010 M in C₆H₆, 0.0050 mmol), appropriate amount of H₂O (0.025 M in C₆H₆), and appropriate amount of C₆H₆ to maintain constant concentration of norbornene (0.50 M) in the reaction mixture between each entry. The solution was then stirred for 10 min at r.t. To the solution was then added a sample of the stock solution of norbornene (1.0 M, 1.0 mL, 1.0 mmol), and the solution was stirred for 10 min, and quenched by addition of 1 mL THF. The polymer was washed three times with 4 mL each of pentane, and dried under vacuum (<0.1 mbar) to form a white solid of I. Table 5 shows the effect of water on the catalytic activity of 9.

TABLE 5
Effect of water on catalytic activity of 9.

| entry | H₂O (mmol) | C₆H₆ (mL) | Yield of I (%) |
|---|---|---|---|
| 1 | 0 | 0.5 | 2 |
| 2 | 0.00125 | 0.45 | 17 |
| 3 | 0.0025 | 0.4 | 31 |
| 4 | 0.00375 | 0.35 | 30 |
| 5 | 0.0050 | 0.3 | 7 |
| 6 | 0.00625 | 0.25 | 0 |

### Example 7

Decomposition Experiment of the Catalysts of this Invention

In a nitrogen glove box, to a J. Young NMR tube was added a sample from the stock solution of 9 (0.60 ml, 0.010 M in C₆H₆, 0.006 mmol). The tube was then heated at 90° C. for 16 h. ¹H NMR showed formation of free PN ligand, however no new paramagnetic species were detected. Analysis of decomposition products by GC-MS showed formation of SiMe₃OH, trans-bis(trimethylsilyl)ethene, and bis(trimethylsilyl)ethane.

### Example 8

### Ru Based Catalyst—Comparative Activity

Preparation of Ru Complex, [RuCl₂(PNdipp-iPr)]₂ (Corresponds to A2 Disclosed Herein)

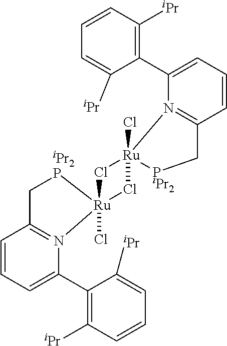

In a nitrogen glove box, a 50 mL Schlenk tube equipped with a Teflon coated stirring bar was charged with [RuCl₂(p-cymene)]₂ (30.9 mg, 0.0505 mmol), PNdipp-ⁱPr (37.5 mg, 0.101 mmol), and 3 mL CH₂Cl₂. The solution was stirred for 20 h at 60° C. outside the box to form a clear dark brown solution. In a nitrogen glove box, the solution was concentrated to dryness and dissolved in 4 mL C₆H₆. The clear dark brown solution was then stirred for 2 weeks at 90° C. outside the box to form a dark brown suspension. In a nitrogen glove box, the suspension was passed through Celite using C₆H₆ to obtain a clear brown solution and dark brown solid. The solid was washed with C₆H₆, and extracted by CH₂Cl₂. Concentration of the extract gave the Ru complex[RuCl₂(PNdipp-iPr)]₂ as a dark brown solid. Yield: 48.1 mg, 88%.

¹H NMR (400.36 MHz, CDCl₃, 298 K): δ 0.65 (6H, dd, ³J_{HH}=6.5 Hz, ³J_{HP}=15.7 Hz, 2PCH(CH₃)₂), 0.85 (12H, m, 2CH(CH₃)₂), 1.2-1.5 (30H, overlapping m, 2CH(CH₃)₂ and 4PCH(CH₃)₂), 2.01 (2H, septet, ³J_{HH}=6.5 Hz, 2CH(CH₃)₂), 2.19 (2H, m, 2PCH(CH₃)₂), 2.40 (2H, m, 2PCH(CH₃)₂), 2.80 (2H, septet, ³J_{HH}=6.5 Hz, 2CH(CH₃)₂), 3.23 (2H, pseudo t, CH₂), 3.66 (2H, dd, ²J_{HH}=10.2 Hz, ²J_{HP}=16.2 Hz, CH₂), 6.83 (2H, d, ³J_{HH}=7.2 Hz, aromatic 2CH), 7.18 (2H, m, aromatic 2CH), 7.29 (4H, overlapping with CHCl₃ peak, aromatic 4CH), 7.40 (2H, d, ³J_{HH}=8.5 Hz, aromatic 2CH), 7.52 (2H, br t, ³J_{HH}=7.5 Hz aromatic 2CH).

¹³C{¹H}NMR (100.67 MHz, CDCl₃, 298 K): δ 17.5 (s, PCH(CH₃)₂), 17.8 (d, ²J_{CP}=7.0 Hz, PCH(CH₃)₂), 19.1 (s, PCH(CH₃)₂), 20.2 (s, PCH(CH₃)₂), 21.8 (s, CH(CH₃)₂), 22.6 (s, CH(CH₃)₂), 24.1 (d, ¹J_{CP}=29.9 Hz, 2PCH(CH₃)₂), 26.4 (s, CH(CH₃)₂), 26.7 (s, CH(CH₃)₂), 30.2 (d, ¹J_{CP}=29.2 Hz, 2PCH(CH₃)₂), 30.6 (s, 2CH(CH₃)₂), 30.8 (s, 2CH(CH₃)₂), 32.5 (d, ¹J_{CP}=24.2 Hz, CH₂), 120.1 (d, ³J_{CP}=10.0 Hz, aromatic), 122.4 (s, aromatic), 123.3 (s, aromatic), 124.9 (s, aromatic), 129.3.6 (s, aromatic), 132.3 (s, aromatic), 135.3 (s, aromatic, ipso), 148.2 (s, aromatic, ipso), 148.7 (s, aromatic, ipso), 165.4 (s, aromatic, ipso), 166.3 (s, aromatic, ipso).

³¹P{¹H}NMR (121.50 MHz, CDCl₃, 292 K): δ 125.7.

HRMS (ESI⁺) m/z caled for C₄₈H₇₂Cl₄N₂P₂Ru₂+([M]⁺): 1082.2012. Found: 1082.1997.

Examination of the catalytic activity of [RuCl₂(PNdipp-iPr)]2 towards ROMP of norbornene.

In a nitrogen glove box, a 20 mL vial equipped with a Teflon coated stirring bar was charged with [RuCl₂(PNdipp-iPr)]₂ (2.7 mg, 0.0025 mmol), trimethylsilylmethyllithium (1.0 mg, 0.011 mmol), and 0.55 mL C₆D₆. The solution was stirred for 15 h at 25° C. NMR analysis of the solution after 15 hours showed complete conversion of [RuCl₂(PNdipp-iPr)]2 to new unidentified complex(es). To the stirred solution was then added solid norbornene (91.2 mg, 0.969 mmol) and 0.45 mL C₆H₆. The solution was stirred for 25 h at 25° C. No formation of polymer was observed before or after concentration of the solution.

### Example 9

### The Effect of the Ligand Structure of the Catalyst of This Invention

The effect of the PN ligand structure was studied by screening several FeCl₂(PN) complexes. Substitution of PⁱPr₂ group by P^{t}Bu₂, PEt₂, and PPh₂ group, as well as substitution of the 2,6-ⁱPr₂C₆H₃ group by the 2,4,6-Me₃C₆H₂ group resulted in an inactive catalyst (complex 5 and 6). Thus, fine tuning of steric and electronic factors of the ligand is essential for the catalytic activity. Significantly, a complex with CMe₂PⁱPr group, (Complex 4) also resulted in formation of an inactive catalyst. This result indicates that dearomatization of the PN ligand is essential for the formation of active catalyst, however the inactivity can also be due to steric effect of the methyl groups as in the case of 11.

### General Procedure for Screening of FeCl₂(PN) Complexes.

In a nitrogen glovₑ box, a 20 mL vial equipped with ^{a} Tₑflon coated stᵢrring bar was cₕₐrged with the appropriate FeCl₂(PN) complex (0.05 mmol), and trimethylsiₗyₗmₑthyllithium (0.10 mmol). 5.00 mL C₆H₆ was then added to the vial. The solution was stirred at r.t. for 6-19 h to form 0.01 M stock solution of the catalyst. Another 20 mL vial equipped with a Teflon coated stirring bar was charged with the stock solution of the appropriate catalyst (1.0 mL, 0.01 mmol). Solid norbornene (1.0 mmol) was then added to the vial, and the solution was stirred for 16 to 30 h. The reaction was quenched by addition of 1 mL THF. The polymer was washed three times with 4 mL each of pentane, and dried under vacuum (<0.1 mbar). Table 6 shows the catalytic activity of FeCl₂(PN) complexes towards ROMP of norbornene.

TABLE 6
Screening of FeCl₂(PN) complexes for ROMP of norbornene.

| entry | FeCl₂(PN) complexes | time (h) | Yield of polymer (%) |
|---|---|---|---|
| 1 | 3 | 30 | 2 |
| 2 | 5 | 16 | trace |
| 3 | 6 | 16 | trace |
| 4 | 7 | 16 | trace |
| 5 | 4 | 12 | 0 |

### Example 10

### Polymerization of Norbornene in the Presence of Equimolar Amount of Styrene

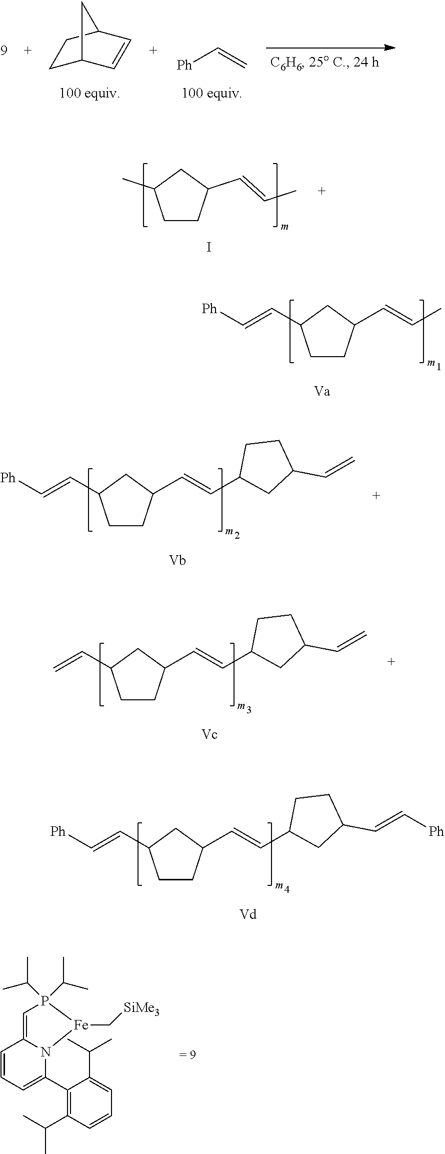

In a nitrogen glove box, a 20 mL vial equipped with a Teflon coated stirring bar was charged with a stock solution of complex 9 (1.0 ml, 0.010 mmol), styrene (104.3 mg, 1.00 mmol), and mesitylene (119.9 mg, 0.998 mmol). To the stirred dark red solution was added solid norbornene (97.6 mg, 1.04 mmol). The vial was sealed tightly using an electrical tape and a plastic cap to avoid loss of norbornene and placed close to the magnetic stirring plate to ensure stirring of the polymer around the stirring bar. After 24 h of stirring at 25° C., viscous solution and precipitation of the polymer were obtained. An aliquot of the reaction mixture was taken to a J. Young NMR tube and diluted by ca. 0.5 mL C₆H₆. The ¹H NMR spectra of the crude mixture showed full conversion of norbornene and formation of polymer containing I, Va-Vd. Virtually no conversion of styrene was observed using mesitylene internal standard. The reaction was quenched by addition of 1 mL THF. The polymer was concentrated to dryness and washed three times with 4 mL each of n-pentane by vigorous stirring of the polymer/n-pentane suspension and dried under vacuum (<1 mbar) to form a white solid of I, Va-Vd. Yield: 88.1 mg, 90%. The polymer was completely dissolved in CDCl₃ and analyzed by ¹H NMR at 25° C. ¹H NMR of the concentrated sample of I, Va-Vd is used to analyze end groups of the polymer. The identity of the end group was determined to be methylene³³ and trans-phenylmethylene groups based on DOSY, ¹H-¹H-gCOSY, and ¹H-¹H coupling constant analysis. A thin film of the polymer for thin film IR analysis was prepared in a nitrogen glove box by depositing dichloromethane solution of I, Va-Vd on KBr disk. Stereochemistry of the polymer was determined using ¹H NMR, IR, and partial epoxidation of the polymer.

¹H NMR of the polymer chain (500.08 MHz, CDCl₃, 298 K): δ 1.06 (1H, pseudo q, CH₂), 1.35 (2H, br, CH₂), 1.77 (2H, br, CH₂), 1.86 (1H, m, CH₂), 2.43 (2H, br, 2CH), 5.34 (2H, br, 2CH).

¹H NMR of the polymer end groups (500.08 MHz, CDCl₃, 298 K): δ 4.86 (1H, d, ³J_{HH}=10.6 Hz, methylene CH), 4.96 (1H, d, ³J_{HH}=17.2 Hz, methylene CH), 5.79 (1H, m, methylene CH), 6.19 (1H, dd, ³J_{HH}=7.9, 15.5 Hz, trans-phenylmethyl CH), 6.35 (1H, d, ³J_{HH}=15.5 Hz, trans-phenylmethyl CH), 7.17 (1H, br t, trans-phenylmethylene aromatic CH), 7.28 (2H, overlapping with CHCl₃ peak, trans-phenylmethylene aromatic 2CH), 7.34 (2H, m, trans-phenylmethylene aromatic 2CH).

Diffusion coefficient of the polymer chain (C₆D₆, 298 K): 3.2×10⁻¹¹ m²/s.

Diffusion coefficient of the end group (C₆D₆, 298 K): 7.0×10⁻¹¹ m²/s.

Diffusion coefficient of residual n-pentane (C₆D₆, 298 K): 2.1×10⁻⁹ m²/s.

¹³C{¹H}NMR (125.75 MHz, CDCl₃, 298 K): 632.2 (CH₂), 41.4 (CH₂), 43.1 (CH), 133.0 (═CH).

IR (KBr, thin film, cm⁻¹): 666 (s, CH₂ rocking), 964 (s, olefinic trans-CH out-of-plane vibration).

GPC: M_{w}=24430 Da, Mₙ=6719 Da, Ð=3.63.

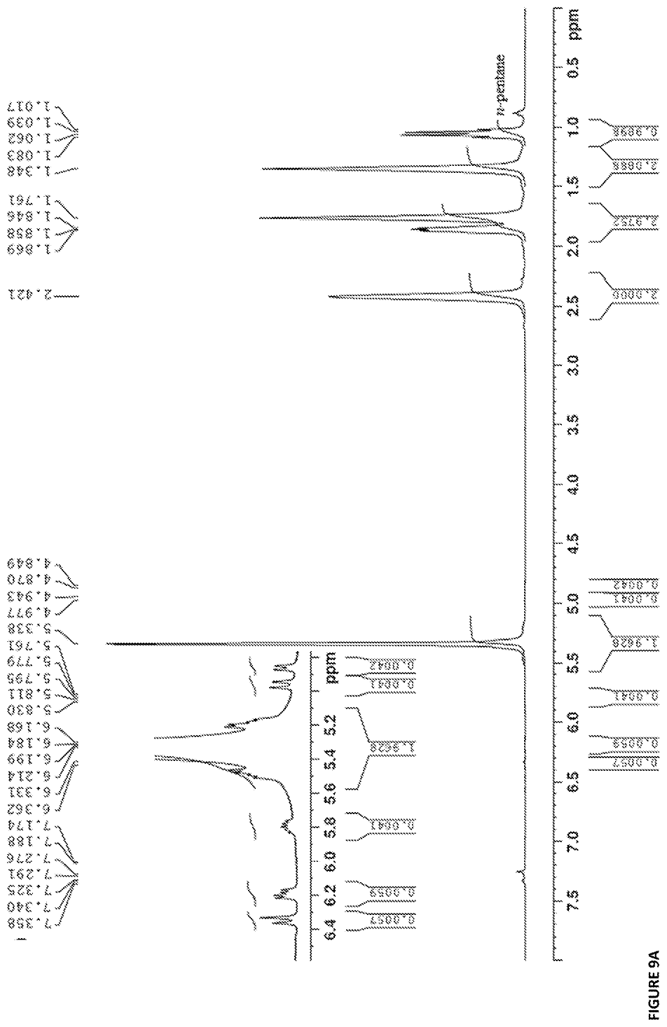

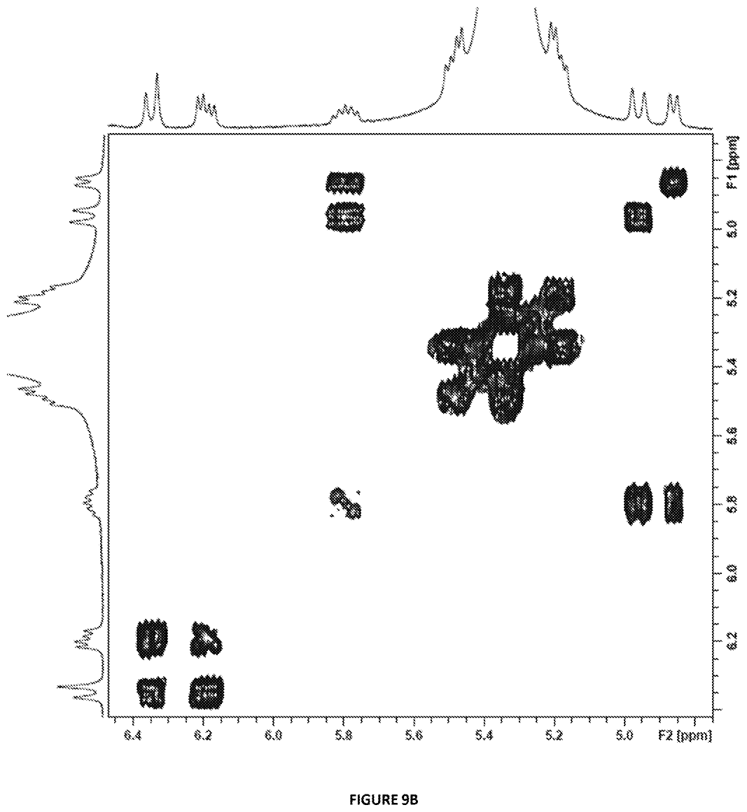

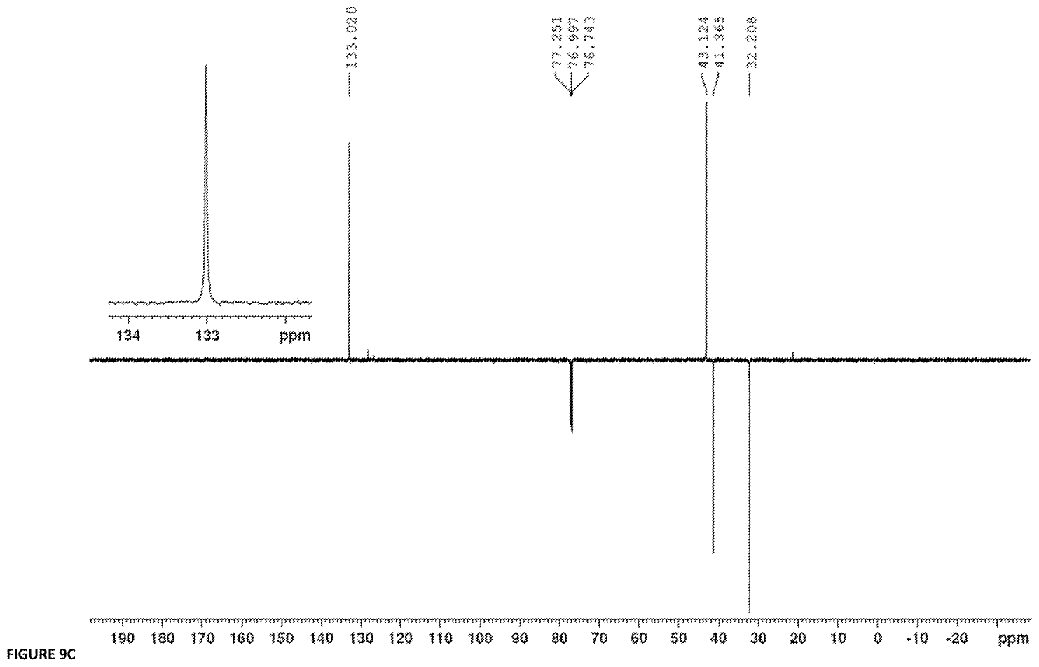

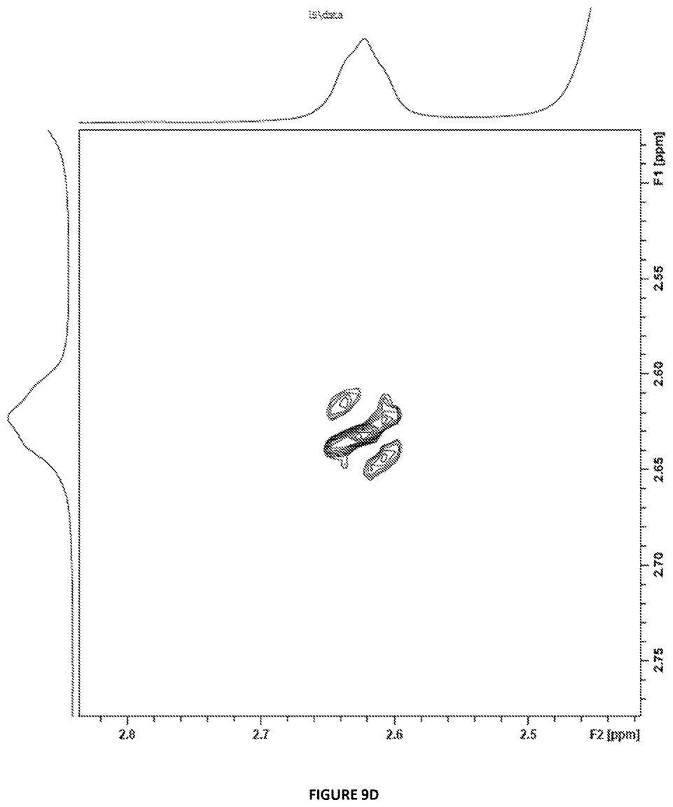

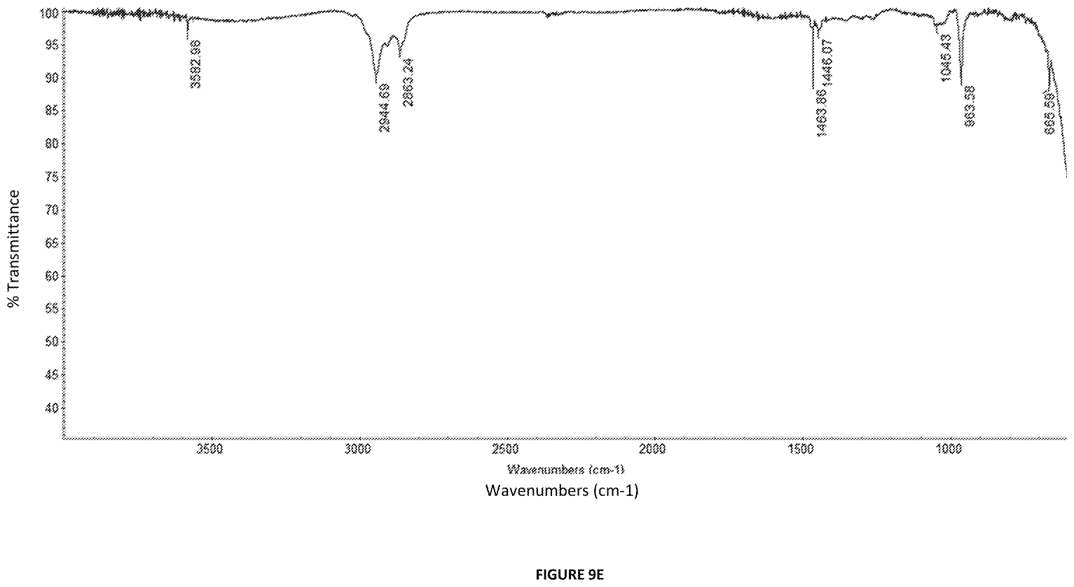

¹H, ¹³C{¹H}, ¹H-¹H-gCOSY NMR, and IR spectra of I, Va-Vd, and, ¹H-¹H-gCOSY NMR spectrum of partially epoxidized I, Va-Vd are shown in FIGS. 9A-9E.

### Example 11

### Polymerization of Norbornene in the Presence of Equimolar Amount of Styrene

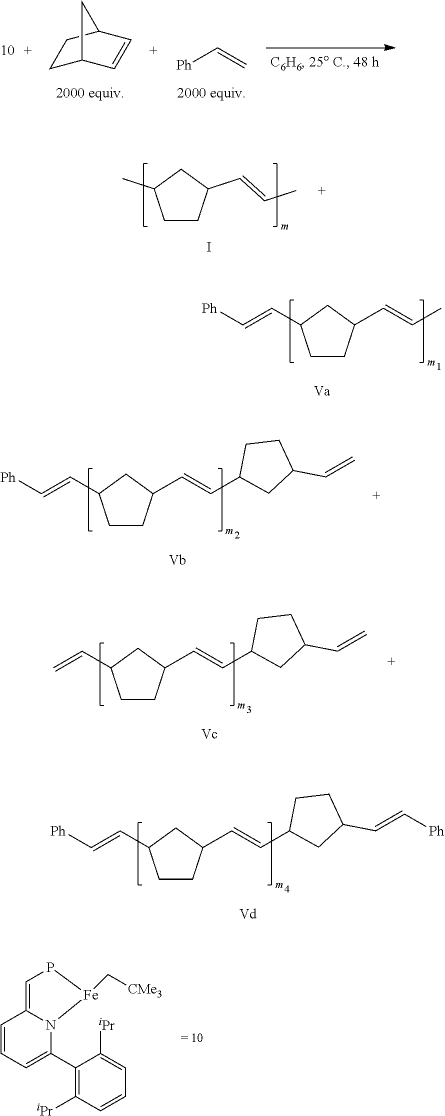

In a nitrogen glove box, a 20 mL vial equipped with a Teflon coated stirring bar was charged with a stock solution of complex 10 (0.50 ml, 0.005 mmol, 0.05 mol %), styrene (1.0436 g, 10.0 mmol), and 4.50 mL C₆H₆. To the stirred pale red solution was added solid norbornene (943.0 mg, 10.0 mmol). The vial was sealed tightly using an electrical tape and a plastic cap to avoid loss of norbornene and placed close to the magnetic stirring plate to ensure stirring of the polymer around the stirring bar. After 48 h of stirring at 25° C., the reaction was quenched by the addition of 1 mL THF, and the reaction mixture was concentrated to dryness. The resulting solid was washed three times with 4 mL each of n-pentane and dried under vacuum (<1 mbar). The solid was completely dissolved in ca. 8 mL boiling CHCl₃ and passed through a plug of silica gel. Concentration of CHCl₃ solution gave faint yellow solid. Yield: 59.1 mg. The polymer was completely dissolved in CDCl₃ and analysed by ¹H NMR at 25° C. ¹H NMR showed formation of trans-polynorbornene along with broad signals in 6.3-7.3 and 1.2-2 ppm region which indicate formation of polystyrene. The ratio of polynorbornene and polystyrene was about 1:6 based on integration of a ¹H NMR spectrum.

### Example 12

### Monitoring of M_{w} of I During the Polymerization in the Presence of Styrene

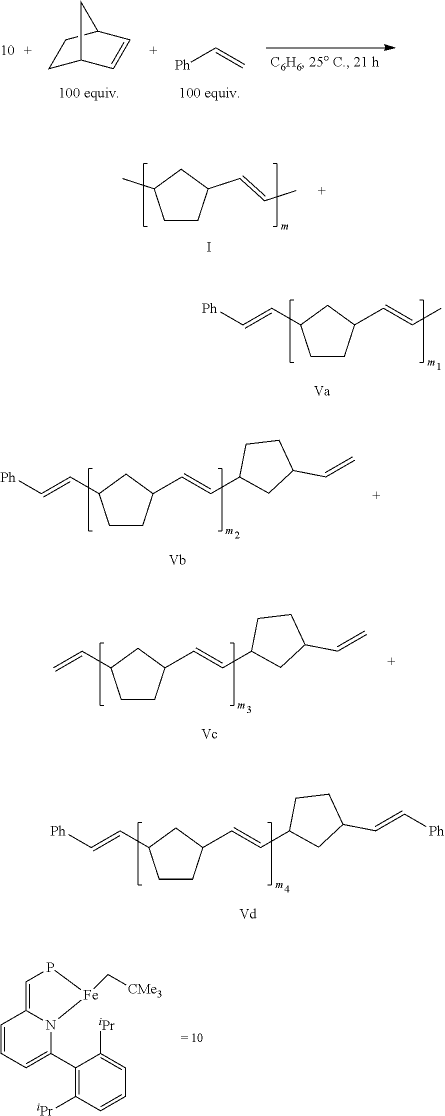

In a nitrogen glove box, 10.0 mL of a 0.010 M solution of Complex 10 was prepared in a 20 mL vial equipped with a Teflon coated stirring bar using 50.1 mg Complex 1, 16.2 mg LiCH₂CMe₃ and 10 mL C₆H₆ as described in Example 3. To the stirred dark red solution at 25° C. was added styrene (1.0419 g, 10.0 mmol), and then solid norbornene (952.9 mg, 10.0 mmol). The vial was sealed tightly using an electrical tape and a plastic cap to avoid loss of norbornene and placed close to the magnetic stirring plate to ensure stirring of the polymer around the stirring bar. Approximately 2 mL of the reaction mixture were taken from the vial after 5, 10, and 21 h, and the catalyst in the collected reaction mixture was quickly deactivated by adding ca. 0.5 mL THF. Aliquot (about one drop) of the collected solution was taken to an NMR tube and dissolved in 0.50 mL CDCl₃. Conversions of norbornene were determined by ¹H NMR using styrene as internal standard (as conversion of styrene is virtually 0%). The remaining collected solutions were concentrated to dryness and dissolved in hot CHCl₃ outside the glovebox. The CHCl₃ solutions were passed through plug of silica gel to remove decomposed iron catalyst. Concentration of CHCl₃ solutions gave colorless films of polymers I, Va-Vd. ¹H NMR spectra of the polymer in CDCl₃ showed clean formation of I, Va-Vd. The polymers were then analysed by GPC as described below. The results of GPC analysis are summarized in Table 7.

TABLE 7
Summary of GPC analysis of polynorbornene (I) prepared
using 1 mol % complex 10 in the presence of styrene.

| Reaction time (h) | Conversion (%) | M_{w} (Da) | Mₙ (Da) | Ð |
|---|---|---|---|---|
| 5 | 68 | 31850 | 8276 | 3.85 |
| 10 | 79 | 29680 | 7603 | 4.40 |
| 21 | 86 | 22800 | 8846 | 2.57 |

* the conversion refers to the conversion of norborene.

GPC measurement of I, prepared in the presence of styrene or 4-(diphenylphosphino)styrene.

GPC samples were prepared by stirring about 80 mg of the polymer (prepared as described above) in 1,2,4-trichlorobenzene at 160° C. Complete dissolution of the polymer was observed. Molecular weights and molecular weight dispersities (Ð) of polymers were determined by the GPC method on the Waters-Alliance 2000 instrument using three Agilent PLgel-Olexis columns (dimensions: 7.5×300 mm, nominal particle size: 13 μm, MW range: 2000 to 10000000 Da), DRI detector, and 1,2,4-trichlorobenzene (with 0.0125% BHT) as the mobile phase at 160° C. and flow rate of 1.00 mL/min. Narrow dispersity polystyrene standards (915000 to 580 Da) were used for the standard calibration curve of the GPC at the same temperature.

### Example 13

Polymerization of Norbornene in the Presence of 4-(diphenylphosphino)styrene

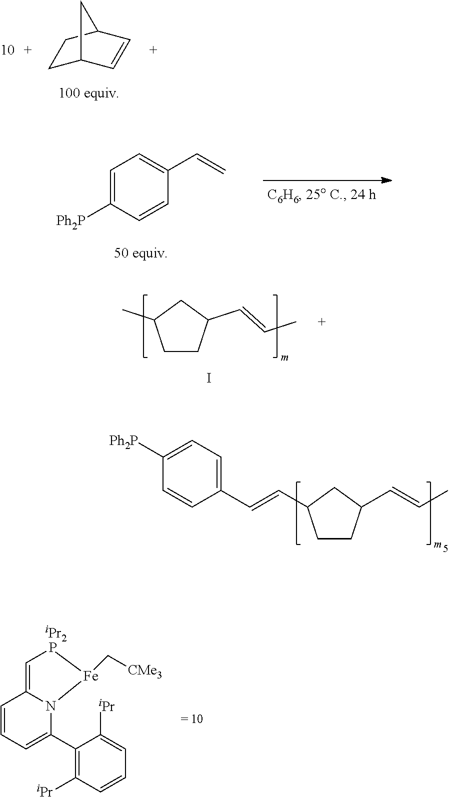

In a nitrogen glove box, a 20 mL vial equipped with a Teflon coated stirring bar was charged with a stock solution of Complex 10 (1.0 ml, 0.010 mmol) and 4-(diphenylphosphino)styrene (143.7 mg, 0.498 mmol). To the stirred dark red solution was added solid norbornene (94.4 mg, 1.00 mmol). The vial was sealed tightly using an electrical tape and a plastic cap to avoid loss of norbornene and placed close to the magnetic stirring plate to ensure stirring of the polymer around the stirring bar. After 40 h of stirring at 25° C., viscous solution and precipitation of the polymer were obtained. The reaction was quenched by addition of 1 mL THF. The polymer was concentrated to dryness and washed five times with 4 mL each of n-pentane by vigorous stirring of the polymer/n-pentane suspension and dried under vacuum (<1 mbar) to form a pink solid of I. Yield: 67.7 mg, 72%. The polymer was completely dissolved in CDCl₃ and analysed by ¹H NMR at 25° C. ¹H NMR of the concentrated sample enable us to analyse end groups of the polymer. The identity of the end group was determined to be methylene and trans-phenylmethylene groups based on ¹H-¹H-gCOSY, and ³¹P{¹H}NMR analysis. Stereochemistry of the polymer was determined by comparing ¹H, ¹³C{¹H}NMR, and IR spectra with those of trans, isotactic I prepared in the absence of 4-(diphenylphosphino)styrene (m₅ in the scheme is as defined for m₁).

¹H NMR of the polymer chain (500.13 MHz, CDCl₃, 298 K): δ 1.05 (1H, pseudo q, CH₂), 1.35 (2H, br, CH₂), 1.76 (2H, br, CH₂), 1.86 (1H, br m, CH₂), 2.42 (2H, br, 2CH), 5.34 (2H, br, 2CH).

¹H NMR of the polymer end groups (500.13 MHz, CDCl₃, 298 K): δ 4.86 (1H, d, ³J_{HH}=9.50 Hz, methylene CH), 4.96 (1H, d, ³J_{HH}=16.5 Hz, methylene CH), 5.79 (1H, m, methylene CH), 6.23 (1H, dd with roofing, ³J_{HH}=7.8, 15.5 Hz, trans-4-(diphenylphosphino)phenylmethylene CH), 6.34 (1H, d, ³J_{HH}=15.5 Hz, trans-4-(diphenylphosphino)phenylmethylene CH), 7.23-7.32 (br, overlapping with CHCl₃ peak, trans-4-(diphenylphosphino)phenylmethylene aromatic CH).

¹³C{¹H}NMR (125.75 MHz, CDCl₃, 298 K): δ 32.2 (CH₂), 41.4 (CH₂), 43.1 (CH), 133.0 (═CH).

³¹P{¹H}NMR (202.46 MHz, CDCl₃, 298 K): δ −6.06 (PPh₂).

IR (KBr, thin film, cm⁻¹): 964 (s, olefinic trans-CH out-of-plane vibration).

GPC: M_{w}=18758 Da, Mₙ=5656 Da, Ð=3.30.

### Example 14

Trapping of Iron-Carbene Intermediate by 2-chlorostyrene

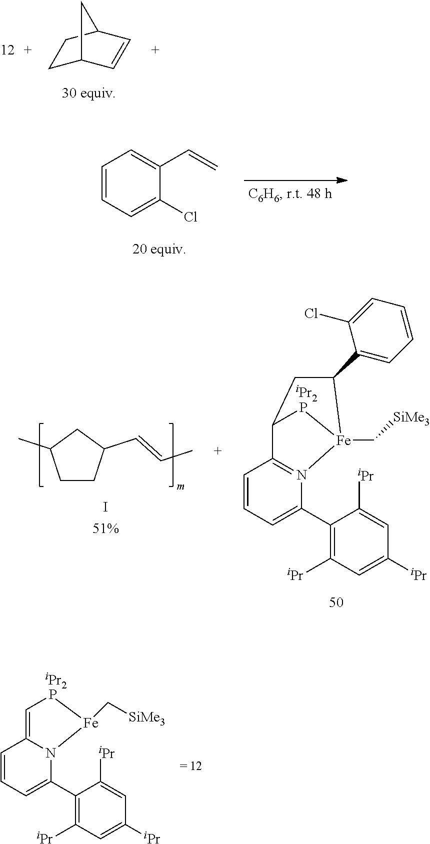

In a nitrogen glove box, to a 20 mL vial equipped with a Teflon coated magnetic stirring bar was weighed 2-chlorostyrene (28.9 mg, 0.209 mmol). Complex 12 (2.0 mL, 0.010 M C₆H₆ solution, 0.020 mmol) and norbornene (27.8 mg, 0.295 mmol) were then added to the vial. The solution was stirred for 48 h and concentrated to dryness. The product was extracted with n-pentane, passed through Celite, and concentrated to ca. 0.1 mL. XRD quality of crystals of 50 were formed upon keeping the solution at −28° C. XRD measurement showed formation of 50. Polynorbornene I (14.2 mg, 51% yield) was obtained in this procedure.

### Example 15

Trapping of Iron-Carbene Intermediate by 2,3,4,5,6-pentafluorostyrene

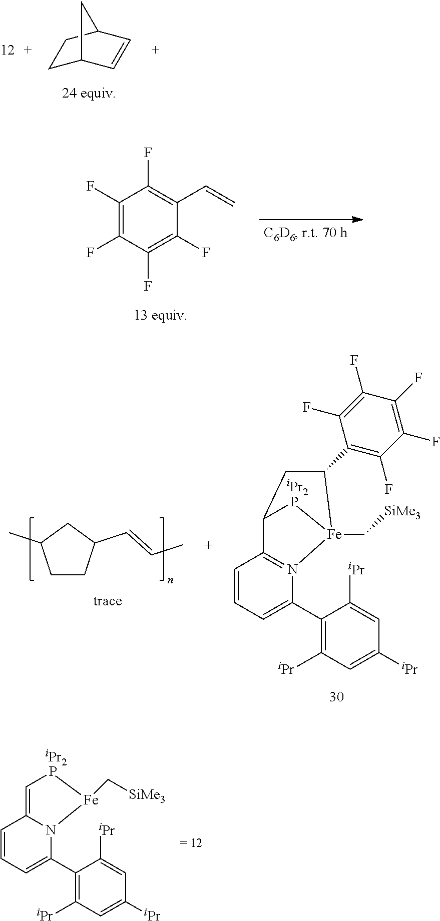

In a nitrogen glove box, to a J. Young NMR tube containing complex 12 (0.020 mmol, prepared using 11.0 mg complex 8 and 4.1 mg LiCH₂SiMe₃ in 0.7 mL C₆D₆) were added 2,3,4,5,6-pentafluorostyrene (50.9 mg, 0.262 mmol) and norbornene (45.8 mg, 0.486 mmol). The solution was left for 70 h at 25° C. ¹H NMR analysis of the resulting red solution showed formation of new paramagnetic species and conversion of most of complex 12. Small amount of insoluble polymer was observed. C₆D₆ was evaporated and the product was extracted with n-pentane, passed through Celite, and concentrated to ca. 0.1 mL. XRD quality of red crystals of 30 were formed upon keeping the solution at −35° C. XRD measurement showed formation of 30.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An iron complex represented by the structures of formula A1, its dimer A2 or its isomers: 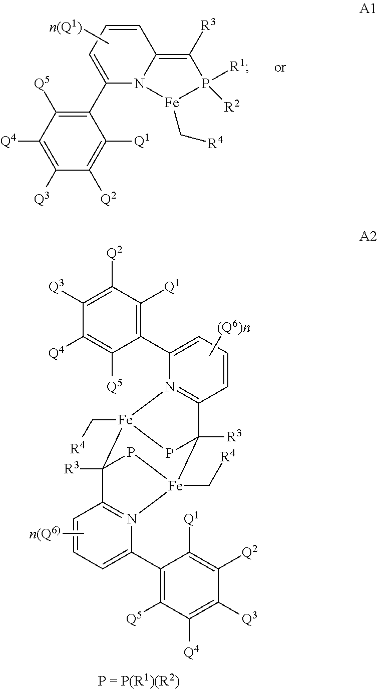
wherein R¹ and R² are each independently linear or branched alkyl, cycloalkyl, aryl, heterocyclyl, alkylcycloalkyl, alkylaryl, or alkylheterocyclyl;
R³ is H, D, linear or branched alkyl;
R⁴ is SiHₓ(alkyl)_{y}(aryl)_{z} or CHₓ(alkyl)_{y}(aryl)_{z}; wherein x is an integer between 0-3; y is an integer between 0-3; z is an integer between 0-3; wherein x+y+z is 3;
Q¹, Q², Q³, Q⁴ Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino;
wherein at least one of Q¹-Q⁵ is an alkyl; and
n is an integer between 1 and 3.

2. The iron complex of claim 1, wherein the iron is iron (III).

3. The iron complex of claim 1, wherein the R¹ and R² are the same; or wherein R¹ and R² are each independently isopropyl, ethyl, phenyl or tertbutyl; or
wherein R³ is H; or wherein R⁴ is Si(CH₃)₃ or C(CH₃)₃; or wherein Q2 and Q4 are H; or
wherein Q1, Q3 and Q5 are each independently isopropyl or tertbutyl; or wherein Q¹, Q⁵ are each independently isopropyl or tertbutyl and Q³ is H.

4-9. (canceled)

10. The iron complex of claim 1, wherein the structure of formula A1 and A2 are in equilibrium in solution.

11. (canceled)

12. The iron complex of claim 1, wherein the complex is represented by the following structures:

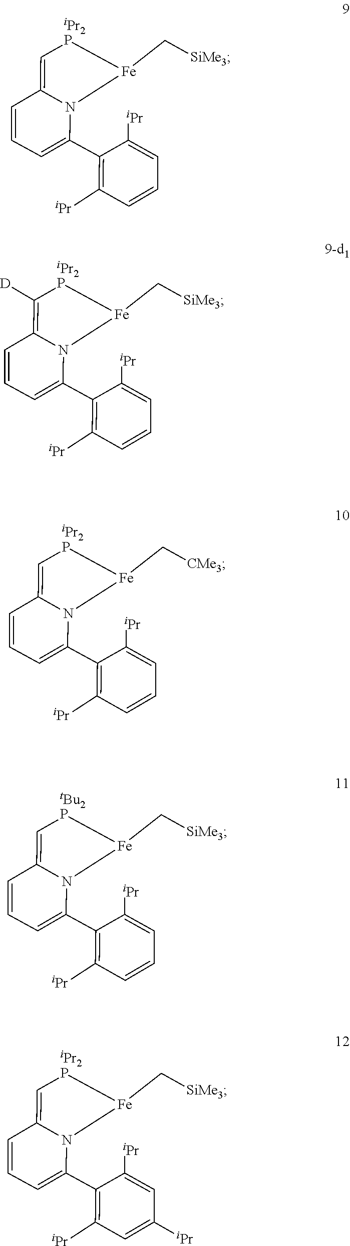

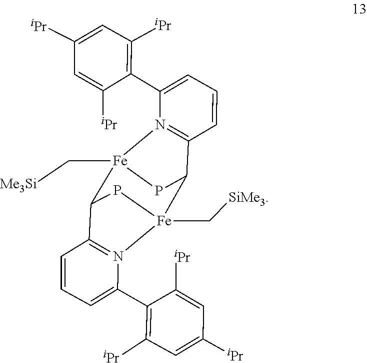

13. A method for metathesis polymerization of cyclic olefins comprising reacting a substituted or unsubstituted cyclic olefin with the iron complex of claim 1, thereby obtaining a polymer by ring opening metathesis polymerization.

14. The method of claim 13, wherein the cyclic olefin has a strain in the ring; or wherein the cyclic olefin comprises norbornene, bicycles, 3, 4 or 5 membered ring; or wherein the cyclic olefin is a carbocycle or heterocycle; or wherein the cyclic olefin is a diene.

15-22. (canceled)

23. The method of claim 13, wherein the cyclic olefin is substituted or unsubstituted norbornene obtaining a substituted or unsubstituted polynorbornene of formula I: 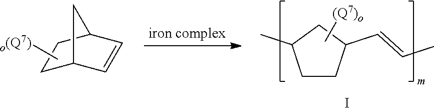
wherein Q⁷ is H, linear or branched alkyl, aryl, heterocyclyl, alkylcycloalkyl, alkylaryl, Si(alkyl)₃, alkylheterocyclyl, halide, nitro, amide, ester, cyano, alkoxy, NH₂, aminoalkyl or arylamino;
o is an integer between 1-3;
m is an integer larger than 2.

24. (canceled)

25. An iron complex represented by the structures of formula A3 or its isomer: 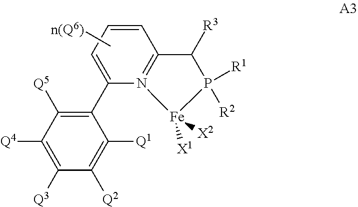
wherein:
R¹ and R² are each independently linear or branched alkyl, cycloalkyl, aryl, heterocyclyl, alkylcycloalkyl, alkylaryl, or alkylheterocyclyl;
R³ is H, D, linear or branched alkyl;
X¹ and X² are each independently Cl, Br, I or F;
Q¹, Q², Q³, Q⁴, Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino;
wherein at least one of Q¹-Q⁵ is alkyl; and
n is an integer between 1 and 3.

26. The iron complex of claim 25, wherein the iron is iron (II).

27. The iron complex of claim 25, wherein the R¹ and R² are the same; or wherein R¹ and R² are each independently isopropyl, ethyl, phenyl or tertbutyl; or wherein R³ is H; or wherein X¹ and X² are independently Br or Cl; or wherein Q² and Q⁴ are H; or wherein Q¹, Q³ and Q⁵ are each independently isopropyl or tertbutyl; or wherein Q¹, Q⁵ are each independently isopropyl or tertbutyl and Q³ is H.

28-33. (canceled)

34. The iron complex of claim 25, wherein the complex is represented by the following structures:

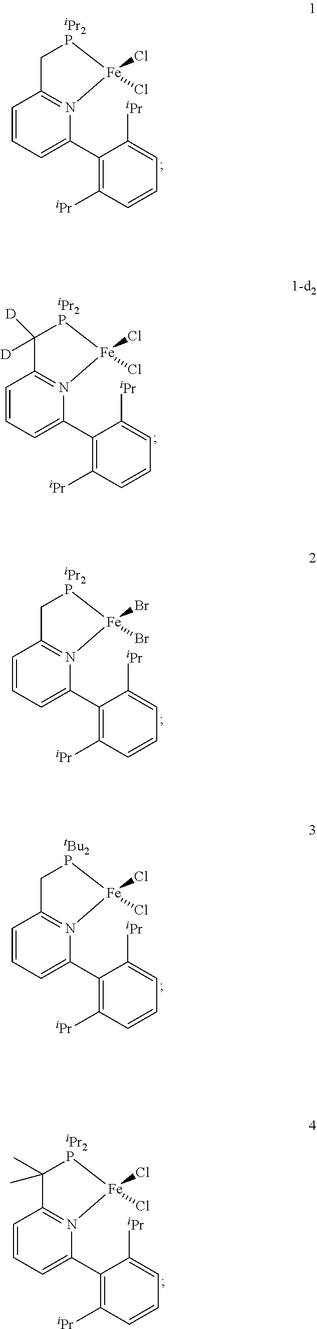

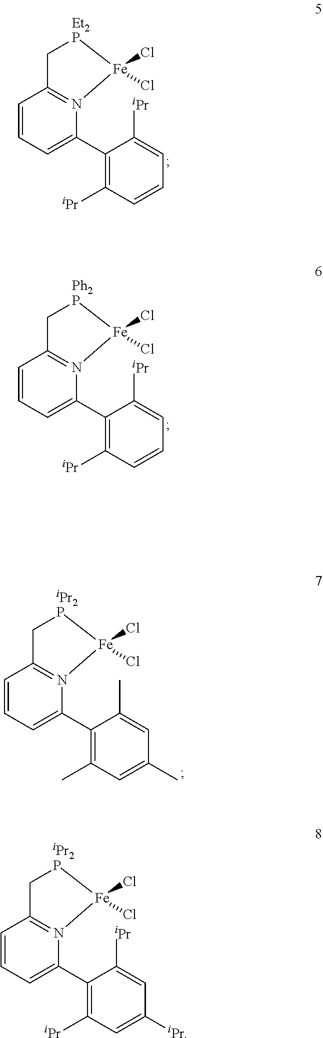

35. A compound represented by the structure of formula B1 or its isomers: 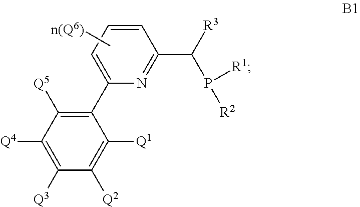
R¹ and R² are each independently linear or branched alkyl, cycloalkyl, heterocyclyl, alkylcycloalkyl, alkylaryl, or alkylheterocyclyl;
R³ is H, D, linear or branched alkyl;
Q¹, Q², Q³, Q⁴ Q⁵ or Q⁶ are each independently H, linear or branched alkyl, aryl, heterocyclyl, alkylcycloalkyl, alkylaryl, alkylheterocyclyl, halide, nitro, amide, ester, cyano, alkoxy, NH₂, aminoalkyl or arylamino;
wherein at least one of Q¹-Q⁵ is alkyl; and
n is an integer between 1 and 3.

36. The compound of claim 35, wherein the compound is represented by the following structures:

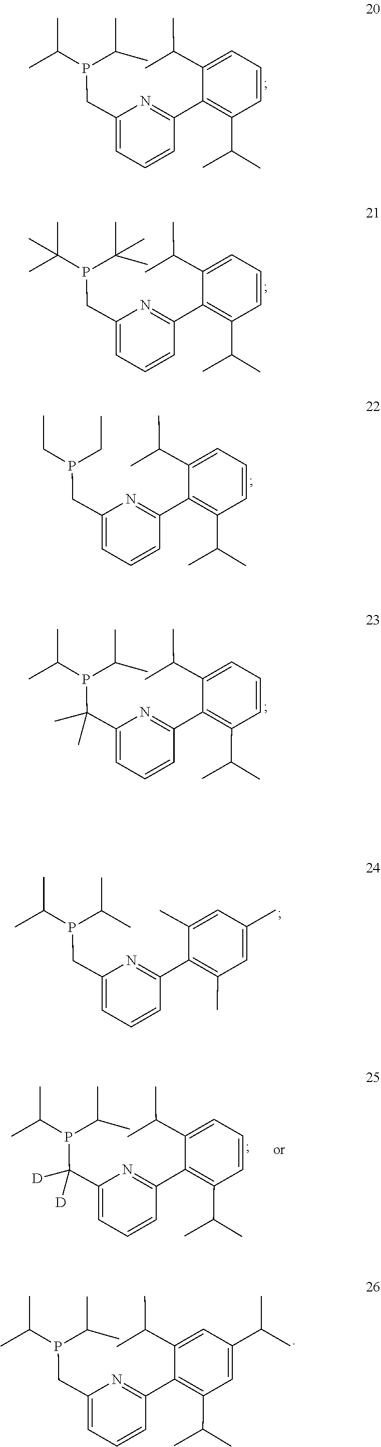

37. The method of claim 13, wherein said polymerization is conducted in the presence of an olefin (R—CH═CH₂, wherein R is substituted or unsubstituted-aryl, phenyl, heteroaryl, alkyl, cycloalkyl or heterocycloalkyl).

38. The method of claim 37, wherein the olefin is styrene, wherein said styrene is optionally in an equimolar amount of the cyclic olefin.

39. (canceled)

40. The method of claim 38, wherein said styrene itself does not undergo polymerization.

41. The method of claim 37, wherein said polymerization produces a polymer that is soluble in an organic solvent.

42. (canceled)

43. The method of claim 38, wherein said method produces a polymer capped by CH-Ph (of styrene).

44. The method of claim 38, wherein said polymer comprises a mixture of compounds I, Va, Vb, Vc and Vd: 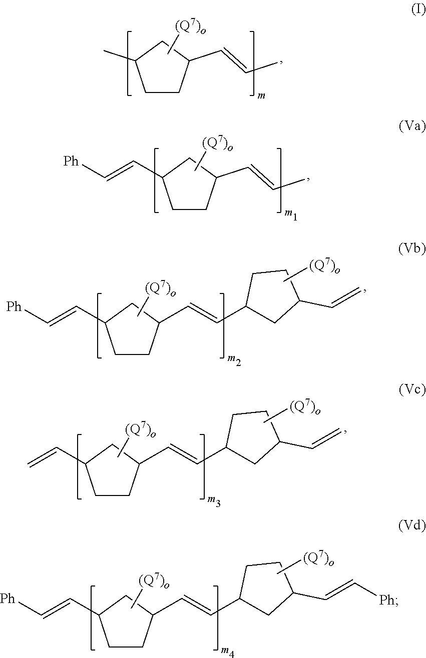
wherein m₁, m₂, m₃, m₄ and m₅ are each an integer of 2-1,000,000; Q⁷ is independently H, linear or branched alkyl, aryl, heterocyclyl, alkylcycloalkyl, alkylaryl, alkylheterocyclyl, Si(alkyl)₃, halide, nitro, amide, ester, cyano, alkoxy, NH₂, aminoalkyl or arylamino; and
o is an integer between 1-3.
